(19) United States
(12) Patent Application Publication
(10) Pub. No.: US 2023/0281587 A1
(43) Pub. Date: Sep. 7, 2023

(54) MOBILE SALES DEVICE AND MOBILE SALES SYSTEM

(71) Applicant: Toshiba Tec Kabushiki Kaisha, Tokyo (JP)

(72) Inventors: Kento KAWATA, Fujisawa Kanagawa (JP); Yumiko OKUMA, Koganei Tokyo (JP); Takahide MATSUMOTO, Higashimurayama Tokyo (JP); Kizuku INOUE, Yokohama Kanagawa (JP)

(21) Appl. No.: 18/156,904

(22) Filed: Jan. 19, 2023

(30) Foreign Application Priority Data
Mar. 1, 2022 (JP) 2022-030931

(51) Int. Cl. G06Q 20/18; G06Q 20/40; G06Q 20/20; G06Q 20/10; B25J 11/00

(52) U.S. Cl. CPC G06Q 20/18; G06Q 20/40145; G06Q 20/203; G06Q 20/4012; G06Q 20/102; G06Q 20/204; B25J 11/008

(57) ABSTRACT

According to one embodiment, a mobile sales device has a storage unit configured to hold items to be sold, a driving unit configured to move the storage unit from location to location, a communication interface configured to connect to a server device, and a processor. The processor is configured to acquire position information indicating a call position designated by a call requesting user from the server device, control the driving unit based on the position information, acquire authentication information from a user at the call position to determine whether the user at the call position is the call requesting user, and permit execution of sales processing relating to items in the storage unit only if the acquired authentication information indicates that the user at the call position is the call requesting user.

### CROSS-REFERENCE TO RELATED APPLICATION

This application is based upon and claims the benefit of priority from Japanese Patent Application No. 2022-030931, filed Mar. 1, 2022, the entire contents of which are incorporated herein by reference.

### FIELD

Embodiments described herein relate generally to a mobile sales device and a mobile sales system.

### BACKGROUND

There has been proposed a mobile robot (also referred to as a shopping support device) that moves within a retail store and supports shopping of a customer in the store. The mobile robot travels within the store and carries an item to be purchased for the customer around the store and then to a register for checkout or the like.

In this way, the mobile robot of the related art only supports the shopping of the customer inside the store and does not itself have a function of selling commodities.

### BRIEF DESCRIPTION OF THE DRAWINGS

FIG. 1 is a diagram illustrating an example of a mobile sales system according to a first embodiment.

FIGS. 2 to 4 are perspective views illustrating an example of an exterior configuration of a mobile sales device according to a first embodiment.

FIG. 5 is a diagram illustrating an example of a hardware configuration of a mobile sales device.

FIG. 6 is a diagram illustrating an example of a data configuration of a commodity master according to a first embodiment.

FIG. 7 is a diagram illustrating an example of a data configuration of a stored commodity table according to a first embodiment.

FIG. 8 is a diagram illustrating an example of a hardware configuration of a user terminal according to a first embodiment.

FIG. 9 is a diagram illustrating an example of a hardware configuration of a server device according to a first embodiment.

FIG. 10 is a diagram illustrating an example of a data configuration of a robot management table according to a first embodiment.

FIG. 11 is a diagram illustrating an example of a data configuration of a commodity management table according to a first embodiment.

FIG. 12 is a diagram illustrating an example of a data configuration of a user management table according to a first embodiment.

FIG. 13 is a diagram illustrating an example of a data configuration of a call management table according to a first embodiment.

FIG. 14 is a diagram illustrating an example of a data configuration of a transaction management table according to a first embodiment.

FIG. 15 is a block diagram illustrating functional aspects of devices of a mobile sales system.

FIG. 16 is a diagram illustrating an example of a first display screen by a user terminal.

FIG. 17 is a diagram illustrating an example of a second display screen by a user terminal.

FIG. 18 is a diagram illustrating an example of a third display screen by a user terminal.

FIG. 19 is a diagram illustrating an example of a fourth display screen by a user terminal.

FIG. 20 is a diagram illustrating an example of a call position designation screen.

FIG. 21 is a diagram illustrating an example of a display screen displayed when a mobile sales device arrives at a call position.

FIG. 22 is a diagram illustrating an example of a display screen displayed when a mobile sales device arrives at a call position.

FIG. 23 is a perspective view illustrating an example of an exterior configuration of a mobile sales device in a modification.

FIGS. 24A and 24B are portions of a sequence chart illustrating an example of an operation of a mobile sales system according to a first embodiment.

FIG. 25 is a flowchart of sales permission processing by a control unit of a mobile sales device according to a first embodiment.

FIG. 26 is a diagram illustrating an example of a display screen displayed when a mobile sales device according to a second embodiment arrives at a call position.

FIG. 27 is a diagram illustrating an example of a display screen displayed when a mobile sales device arrives at a call position.

FIGS. 28A and 28B are portions of a sequence chart illustrating an example of an operation of a mobile sales system according to a second embodiment.

### DETAILED DESCRIPTION

At least one embodiment provides a mobile sales device and a mobile sales system capable of moving to a position that has been requested by a user and then preferentially selling commodities to the requesting user.

According to one embodiment, a mobile sales device has a storage unit configured to hold items to be sold, a driving unit configured to move the storage unit from location to location, a communication interface configured to connect to a server device, and a processor. The processor is configured to acquire position information indicating a call position designated by a call requesting user from the server device, control the driving unit based on the position information, acquire authentication information from a user at the call position to determine whether the user at the call position is the call requesting user, and permit execution of sales processing relating to items in the storage unit only if the acquired authentication information indicates that the user at the call position is the call requesting user.

Certain example embodiments are explained with reference to the drawings. The present disclosure is not limited to the specific example embodiments explained below.

### First Embodiment

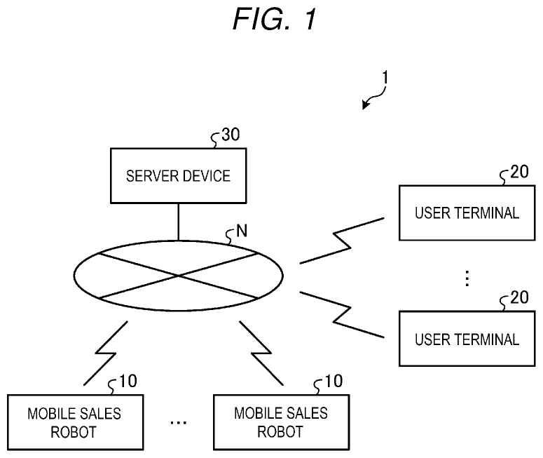

FIG. 1 is a diagram illustrating an example of a configuration of the mobile sales system according to the first embodiment. As illustrated in FIG. 1, a mobile sales system 1 includes mobile sales robots 10, user terminals 20, and a server device 30. The mobile sales robots 10, the user terminals 20, and the server device 30 are connected to a network N such as a LAN (Local Area Network).

Each of the mobile sales robots 10 is a self-propelled sales device that transports and sells commodities in an automated manner. The mobile sales robot 10 is an example of a mobile sales device. For example, the mobile sales robot 10 travels within a predetermined range or area such as of shopping mall or the like and sells commodities at various positions within the traveling range/area. The mobile sales robot 10 may perform patrol traveling (circuit travel) on a predetermined route and/or call (on-demand) traveling involving traveling to a call position as designated by a customer. The number of mobile sales robots 10 is not limited.

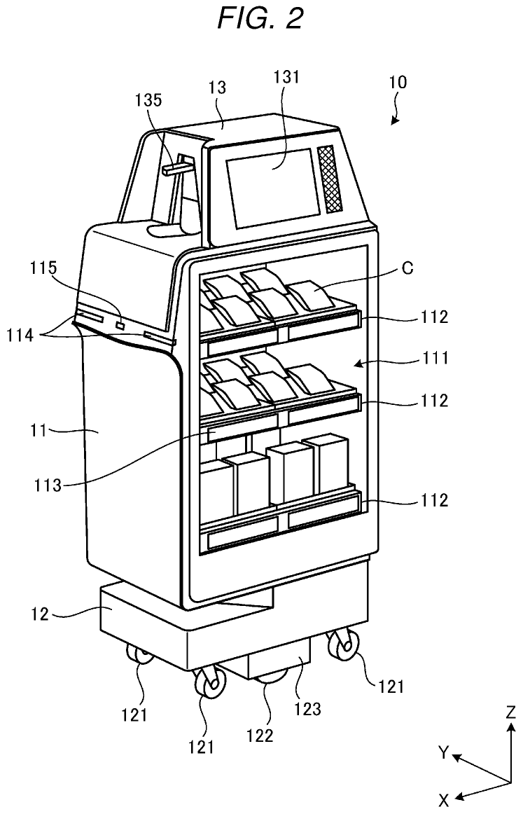

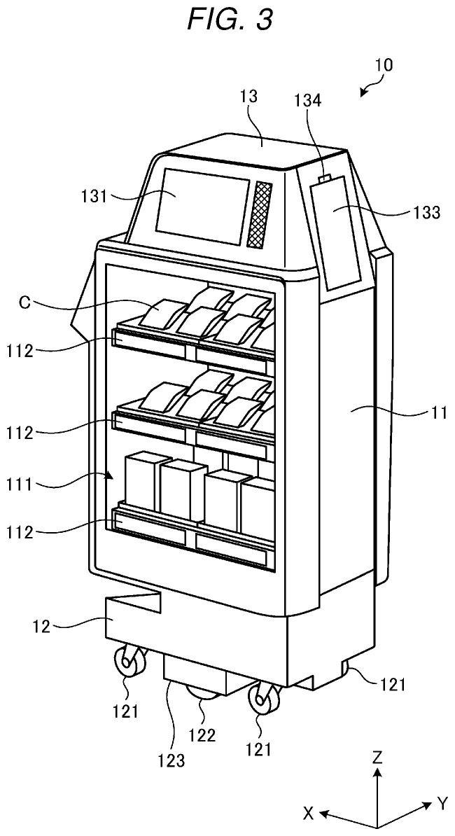

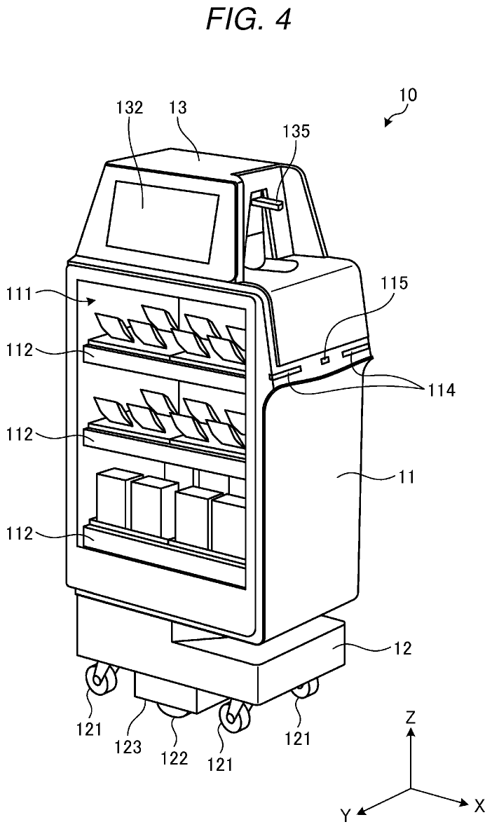

An exterior configuration of the mobile sales robot 10 is explained with reference to FIGS. 2 to 4. FIGS. 2 to 4 are perspective views illustrating an example of the exterior configuration of the mobile sales robot 10.

A configuration of the mobile sales robot 10 is explained using three axial directions of an X axis, a Y axis, and a Z axis orthogonal to one another. In the following explanation, the left side (a Y-axis negative direction side) of the mobile sales robot 10 is referred to as front side of the mobile sales robot 10. The right side (a Y-axis positive direction side) of the mobile sales robot 10 is referred to as rear side of the mobile sales robot 10.

The mobile sales robot 10 includes a main body unit 11, a moving unit 12, and a user interface unit 13. The main body unit 11 is formed by a box-like housing opened on the front and rear sides. A storing unit 111 is provided on the inside of the main body unit 11.

The storing unit 111 (storage unit) provides a space for storing commodities C to be sold, such as food. Shelves 112 on which the commodities C can be displayed are disposed in the storing unit 111 in multiple stages vertically in the front-rear direction of the mobile sales robot 10. The commodities C are placed on the shelves 112 by a store clerk or the like who manages the mobile sales robot 10. The commodities C stored in the storing unit 111 are not limited to foods and may be commodities of other types such as medicines or leisure goods. The storing unit 111 may store commodities C of a plurality of types.

The shelves 112 may be divided into a plurality of regions, for example, in order to classify and place the commodities C of the same types in the same regions. In this case, the shelves 112 may be divided into a plurality of regions by using, for example, trays.

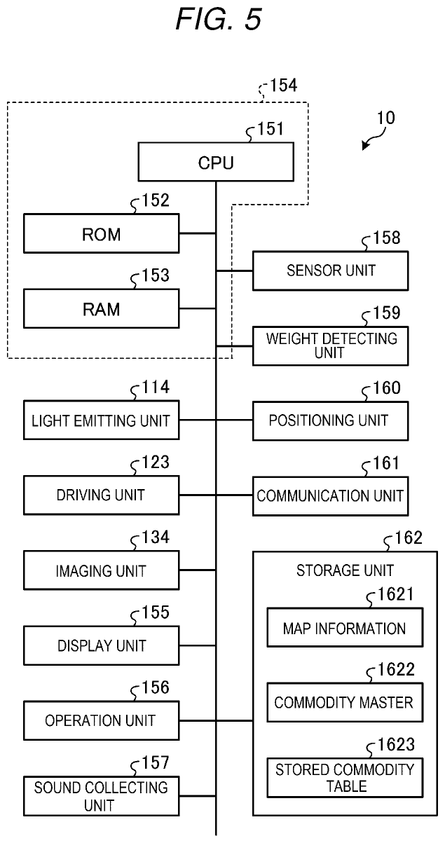

On the front side of the shelves 112, shelf labels 113 for displaying names and prices of the commodities C are provided. The shelf labels 113 may be so-called electronic shelf labels or digital signages for digitally displaying information. In each of the shelves 112, a weight detecting unit 159 (see FIG. 5) capable of detecting the weight of the commodities C placed on the shelf 112 is provided. The weight detecting unit 159 is a detecting unit for detecting a weight change to thereby detect when a commodity C is removed from the shelf 112 or returned to the shelf 112.

In this embodiment, the shelf labels 113 are provided on the front side of the shelves 112. However, the shelf labels 113 may be provided on the rear side of the shelves 112. In this embodiment, both of the front side and the rear side of the main body unit 11 (the storing unit 111) are open. However, in some examples, just one side (for example, the front side) may be open.

A door formed by a light transmissive member such as glass may be attached on one or both of the front side and the rear side of the main body unit 11 (the storing unit 111) to make it possible to access the inside of the storing unit 111 via the door. For example, the door may be attached to the front side of the main body unit 11 and the rear side of the main body unit 11 may be covered by a wall surface. In this case, the wall surface on the rear side may be formed using the light transmissive member such as glass. Consequently, it is possible to prevent commodities in the storing unit 111 from falling out when the mobile sales robot 10 moves or the like.

Further, an electronic lock or the like may be provided in the door to make it possible to lock the door. Consequently, it is also possible to prevent the commodities in the storing unit 111 from being fraudulently taken out during movement/travel of the mobile sales robot 10.

A light emitting unit 114 and a distance measurement sensor 115 are provided on the front side of the main body unit 11. The light emitting unit 114 includes a light emitting element such as an LED (Light Emitting Diode) and emits light according to control of a control unit 154 to inform an operation state of the mobile sales robot 10. For example, the light emitting unit 114 emits light when the mobile sales robot 10 moves to inform people around the mobile sales robot 10 that the mobile sales robot 10 is moving.

A light emission color of the light emitting unit 114 is not limited to a single color. For example, the light emitting unit 114 may vary the light emission color and change a light emission pattern according to an operation state of the mobile sales robot 10. The light emitting unit 114 may be provided on the rear side of the main body unit 11 instead of the front side of the main body unit 11 in some examples.

The distance measurement sensor 115 is a sensor device for detecting an object around the mobile sales robot 10 and detecting the distance to the object. A sensing result of the distance measurement sensor 115 is output to the control unit 154 and used to avoid collisions when moving and detect a user. The distance measurement sensor 115 can be realized by, for example, a sensor device that performs object detection and distance measurement with a captured image or ultrasound or a sensor device such as LiDAR (Light Detection and Ranging) that performs object detection with laser light.

A position where the distance measurement sensor 115 is provided is not limited to the front of the mobile sales robot 10. For example, the distance measurement sensor 115 may be provided in another position such as the rear of the mobile sales robot 10. An imaging unit 134 may be used as the distance measurement sensor 115.

The moving unit 12 is provided under the main body unit 11 and supports the main body unit 11 and permits the mobile sales robot 10 to move. Specifically, the moving unit 12 includes four non-driving wheels 121, two driving wheels 122, and a driving unit 123 that drives the driving wheels 122.

The non-driving wheels 121 are small wheels. The non-driving wheels 121 freely change a direction according to the direction of force generated by rotation of the driving wheels 122 to change a traveling direction of the mobile sales robot 10.

The driving wheels 122 are driven to rotate by the driving unit 123 (e.g., by one or more motors or the like) to thereby move forward and backward or rotate the mobile sales robot 10.

The user interface unit 13 is provided on the main body unit 11. The user interface unit 13 includes a first display unit 131, a second display unit 132, a third display unit 133, an imaging unit 134, and a disinfection device 135.

The first display unit 131 is a display device set on the front side of the mobile sales robot 10. The second display unit 132 is a display device set on the rear side of the mobile sales robot 10. The third display unit 133 is a display device set on a backward side of the mobile sales robot 10. The first display unit 131, the second display unit 132, and the third display unit 133 displays various kinds of information relating to sales and the like of the commodities C according to the control of the control unit 154.

The imaging unit 134 is set on the backward side of the mobile sales robot 10. The imaging unit 134 is a digital camera including an imaging element such as a CCD (Charge Coupled Device) or a CMOS (Complementary MOS). The imaging unit 134 images a user using the mobile sales robot 10 to acquire a face image and the like of the user.

The disinfection device 135 is a device for the user using the mobile sales robot 10 to perform a disinfection process. In this context, a disinfection process means killing, removing, or otherwise rendering harmless pathogenic bacteria, viruses, and other microorganisms that might be present in or on an object. The disinfection can be referred to degerming, pasteurization, or sterilization.

A device configuration of the disinfection device 135 does not matter in particular. For example, the disinfection device 135 may be a sprayer device that sprays a disinfection solution such as alcohol. The disinfection device 135 may be an ultraviolet disinfection device that emits an ultraviolet ray. The disinfection device 135 performs a disinfection operation such as the spray of the disinfection solution and the irradiation of the ultraviolet ray according to user operation.

An operation state of the disinfection device 135 may be electrically output to the control unit 154. In this case, for example, the user interface unit 13 or the disinfection device 135 includes a sensor device (also referred to as disinfection-operation detecting unit) that detects a disinfection operation of the disinfection device 135. If detecting that the disinfection operation is performed by the disinfection device 135, the disinfection-operation detecting unit outputs a detection signal to the control unit 154.

A configuration of the user interface unit 13 is not limited to an illustrated example. For example, the number and setting positions of display devices included in the user interface unit 13 are not limited to the illustrated example. The user interface unit 13 may not include the disinfection device 135. Further, the user interface unit 13 may include a reader device that reads information retained in a code symbol such as a two-dimensional code or a reader device that reads information from a card medium such as an IC card or a credit card.

Referring back to FIG. 1, the user terminal 20 is a device used by the user of the mobile sales system 1 and is an example of a terminal device. The user terminal 20 is realized by a portable terminal device such as a smartphone or a tablet terminal. The user terminal 20 receives a call request for requesting a call for the mobile sales robot 10 from the user and transmits the received call request to the server device 30. The number of user terminals 20 is not limited to the example illustrated in FIG. 1.

The server device 30 manages the mobile sales system 1. The server device 30 is realized by, for example, an information processing device such as a PC (Personal Computer). The server device 30 tracks commodities sold by each of the mobile sales robots 10. The server device 30 manages the mobile sales robot 10 and causes the mobile sales robot 10 to travel to a call position designated by a call request received from a user terminal 20. For example, the server device 30 tracks present positions of the mobile sales robots 10 and the user terminals 20 and, upon receiving a call request for a mobile sales robot 10 from a user terminal 20, causes the mobile sales robot 10 designated by the call request to travel toward the position of the user terminal 20.

Hardware configurations and functional aspects of the devices included in the mobile sales system 1 are explained below.

First, a hardware configuration of the mobile sales robot 10 is explained. FIG. 5 is a diagram illustrating an example of the hardware configuration of the mobile sales robot 10. As illustrated in FIG. 5, the mobile sales robot 10 includes a CPU (Central Processing Unit) 151, a ROM (Read Only Memory) 152, and a RAM (Random Access Memory) 153.

The CPU 151 is an example of a processor and collectively controls the units of the mobile sales robot 10. The ROM 152 stores various programs. The RAM 153 is a work space in which programs and various data are loaded.

The CPU 151, the ROM 152, and the RAM 153 are connected via a bus or the like and constitute the control unit 154. In the control unit 154, the CPU 151 operates according to programs stored in a storage unit 162 and loaded in the RAM 153 to thereby execute various kinds of processing.

The mobile sales robot 10 includes the light emitting unit 114, the driving unit 123, and the imaging unit 134. The mobile sales robot 10 includes a display unit 155, an operation unit 156 (user input device), a sound collecting unit 157, a sensor unit 158, the weight detecting unit 159, a positioning unit 160, a communication unit 161, and the storage unit 162.

The display unit 155 is a display device such as the first display unit 131, the second display unit 132, and the third display unit 133. The display unit 155 can be an LCD (Liquid Crystal Display) screen or the like. The display unit 155 displays various kinds of information under control of the CPU 151. If the shelf label 113 is an electronic shelf label, the display unit 155 may include the electronic shelf label.

The operation unit 156 is an input device such as a keyboard or a pointing device. The operation unit 156 outputs operation content received from the user to the CPU 151. The operation unit 156 may be a touch panel provided on a display screen of the display unit 155.

The sound collecting unit 157 collects sound around the mobile sales robot 10 and outputs a sound signal of the collected sound to the CPU 151. The sound collecting unit 157 is realized by a sound collecting device such as a microphone. The sound collecting unit 157 collects, for example, voice for stopping traveling from a user who desires to purchase a commodity during the patrol traveling of the mobile sales robot 10.

The sensor unit 158 is a sensor device such as the distance measurement sensor 115 or the disinfection-operation detecting unit. The sensor unit 158 outputs a detection result obtained by sensing to the CPU 151.

The weight detecting unit 159 is a weight sensor that detects the weight of commodities stored in the storing unit 111. Specifically, the weight detecting unit 159 is provided in each of the shelves 112 and detects the weight and a weight change of commodities placed on the shelf 112.

Each of the shelves 112 and the weight detecting unit 159 provided in the shelf 112 are correlated with each other in advance. If a weight change is detected by the weight detecting unit 159, it is possible to specify the shelf 112 where the change occurs.

If the shelves 112 are divided into a plurality of regions, the weight detecting unit 159 may be provided in each of the divided regions. In this case, the divided regions and the weight detecting units 159 provided in the regions are correlated.

The positioning unit 160 measures a position where the mobile sales robot 10 is present. The positioning unit 160 can be realized by a positioning device that uses a positioning technique such as a GPS (Global Positioning System).

The positioning unit 160 may be realized by a position measuring device that uses a positioning technique such as beacon positioning or RFID (Radio Frequency Identifier) positioning. In this case, by providing terminals adapted to the positioning technique such as the beacon positioning or the RFID positioning in positions in a movable range of the mobile sales robot 10, it is possible to measure (specify), with a positioning system formed by the terminal and the positioning unit 160, a position where the mobile sales robot 10 is present.

The communication unit 161 is a wireless communication interface connectable to the network N. The communication unit 161 performs communication with an external device such as the server device 30 via the network N.

The storage unit 162 includes a storage medium such as a HDD (Hard Disk Drive) or a flash memory and maintains stored content even if the mobile sales robot 10 is turned off. The storage unit 162 stores programs executable by the CPU 151 and various kinds of setting information.

The storage unit 162 stores map information 1621, a commodity master 1622, and a stored commodity table 1623. The map information 1621 is information indicating a map of a range in which the mobile sales robot 10 moves.

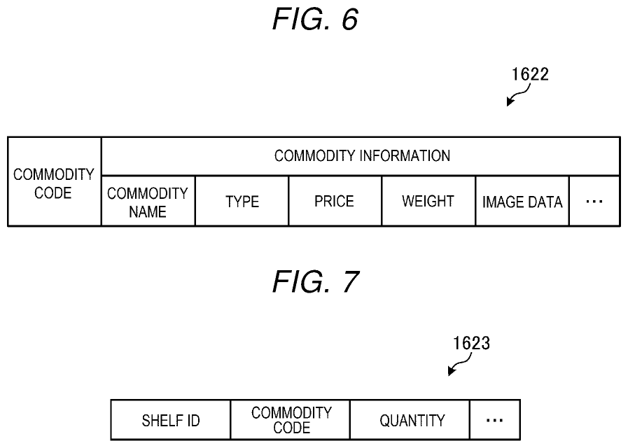

The commodity master 1622 is a data table storing information concerning sales target commodities. FIG. 6 is a diagram illustrating an example of a data configuration of the commodity master 1622. As illustrated in FIG. 6, the commodity master 1622 stores, in correlation with a commodity code for identifying a commodity, commodity information of the commodity corresponding to the commodity code. The commodity information includes a commodity name, a type, a price, a weight, image data, and the like.

The data configuration of the commodity master 1622 is not limited to the example illustrated in FIG. 6. For example, the commodity master 1622 may store the commodity information including image data representing characteristics of the commodity.

The storage unit 162 may not store the commodity master 1622. In this case, by referring to a commodity master 3162 stored in the server device 30, the mobile sales robot 10 can treat the commodity master 3162 in the same manner as in the configuration in which the commodity master 1622 is stored.

The stored commodity table 1623 is a data table for storing information concerning the commodities stored in the storing unit 111. FIG. 7 is a diagram illustrating an example of a data configuration of the stored commodity table 1623. As illustrated in FIG. 7, the stored commodity table 1623 stores, in correlation with a shelf ID capable of identifying each of the shelves 112 provided in the storing unit 111, a commodity code of a commodity placed on the shelf 112 having the shelf ID and a quantity of the placed commodity.

The data configuration of the stored commodity table 1623 is not limited to the example illustrated in FIG. 7. For example, if the shelves 112 are divided into a plurality of regions, the stored commodity table 1623 may allocate an identifier to each of the divided regions and stores a commodity code of a commodity placed in the region and a quantity of the commodity in correlation with each other.

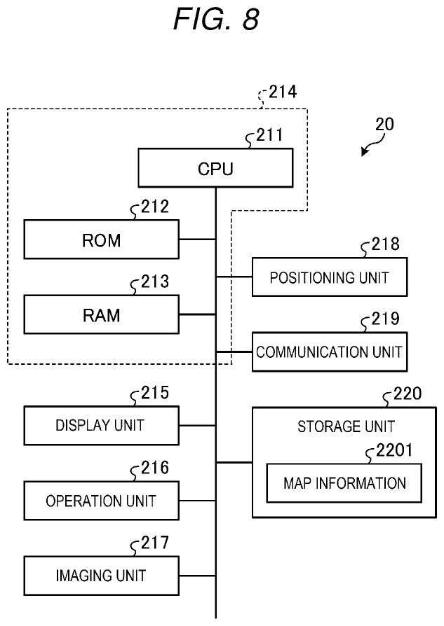

Subsequently, a hardware configuration of the user terminal 20 is explained. FIG. 8 is a diagram illustrating an example of the hardware configuration of the user terminal 20. As illustrated in FIG. 8, the user terminal 20 includes a CPU 211, a ROM 212, and a RAM 213.

The CPU 211 is an example of a processor and collectively controls the units of the user terminal 20. The ROM 212 stores various programs. The RAM 213 is a work space in which programs and various data are loaded.

The CPU 211, the ROM 212, and the RAM 213 are connected via a bus or the like and constitute a control unit 214. In the control unit 214, the CPU 211 operates according to a control program stored in a storage unit 220 and loaded in the RAM 213 to thereby execute various kinds of processing.

The user terminal 20 includes a display unit 215, an operation unit 216, an imaging unit 217, a positioning unit 218, a communication unit 219, the storage unit 220, and the like.

The display unit 215 is a display device such as an LCD screen or the like. The display unit 215 displays various kinds of information under control of the CPU 211. The operation unit 216 is an input device such as a keyboard or a pointing device. The operation unit 216 outputs operation content received from a user to the CPU 211. The operation unit 216 may be a touch panel provided on a display screen of the display unit 215.

The imaging unit 217 can be a digital camera including an imaging element such as a CCD or a CMOS. The imaging unit 217 images a user of the user terminal 20 to acquire a face image of the user.

The positioning unit 218 measures a position where the user terminal 20 is present. The positioning unit 218 can be realized by a positioning device that uses a positioning technique such as a GPS. Like the positioning unit 160, the positioning unit 218 may be realized by a position measuring device that uses a positioning technique such as beacon positioning or RFID positioning.

The communication unit 219 is a wireless communication interface connectable to the network N. The communication unit 219 performs communication with an external device such as a server device 30 via the network N.

The storage unit 220 includes a storage medium such as a HDD or a flash memory and maintains stored content even if the user terminal 20 is turned off. The storage unit 220 stores programs (including an application program concerning processing of the mobile sales system 1) executable by the CPU 211 and various kinds of setting information.

The storage unit 220 stores map information 2201 and the like. Like the map information 1621, the map information 2201 is information indicating the map of the range in which the mobile sales robot 10 moves.

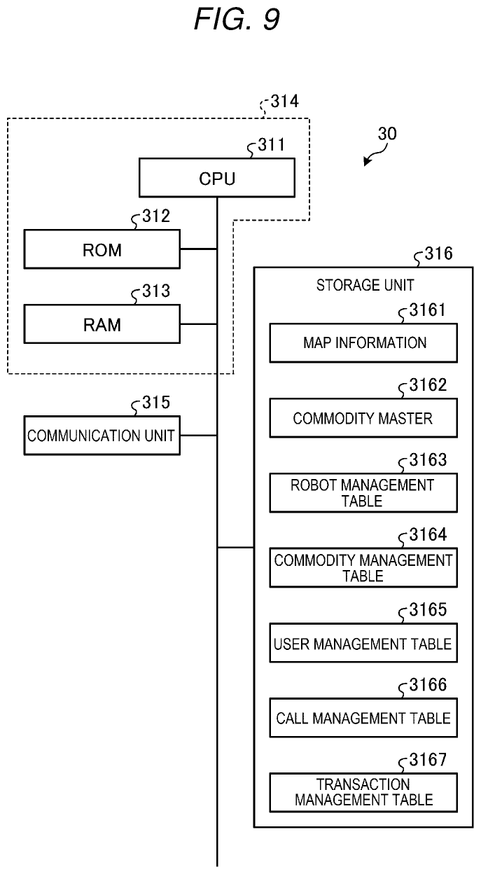

Subsequently, a hardware configuration of the server device 30 is explained. FIG. 9 is a diagram illustrating an example of the hardware configuration of the server device 30. As illustrated in FIG. 9, the server device 30 includes a CPU 311, a ROM 312, and a RAM 313.

The CPU 311 is an example of a processor and collectively controls the units of the server device 30. The ROM 312 stores various programs. The RAM 313 is a work space in which programs and various data are loaded.

The CPU 311, the ROM 312, and the RAM 313 are connected via a bus and form a control unit 314. In the control unit 314, the CPU 311 operates according to a control program stored in a storage unit 316 and loaded in the RAM 313 to thereby execute various kinds of processing.

The server device 30 includes a communication unit 315 and the storage unit 316. The communication unit 315 is a wired or wireless communication interface connectable to the network N. The communication unit 315 performs communication with external devices such as the mobile sales robot 10 and the user terminal 20 via the network N.

The storage unit 316 includes a storage medium such as a HDD or a flash memory and maintains stored content even if the server device 30 is turned off. The storage unit 316 stores programs executable by the CPU 311 and various kinds of setting information.

The storage unit 316 stores map information 3161 and a commodity master 3162. The map information 3161 is information indicating the map of the range in which the mobile sales robot 10 moves. The commodity master 3162 is a data table storing information concerning sales target commodities. A data configuration of the commodity master 3162 is the same as the data configuration of the commodity master 1622.

The storage unit 316 stores a robot management table 3163, a commodity management table 3164, a user management table 3165, a call management table 3166, and a transaction management table 3167.

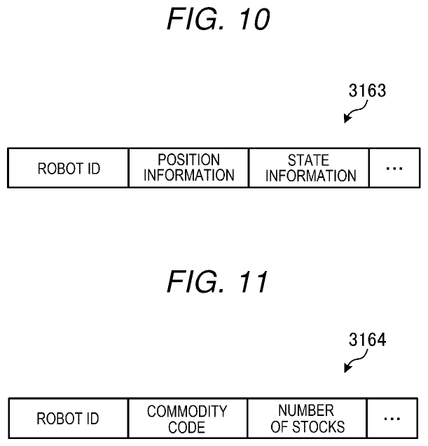

The robot management table 3163 is a data table for managing a position and a state of the mobile sales robot 10. FIG. 10 is a diagram illustrating an example of a data configuration of the robot management table 3163. As illustrated in FIG. 10, the robot management table 3163 stores, in correlation with a robot ID, position information indicating a present position of the mobile sales robot 10 corresponding to the robot ID and state information indicating a state of the mobile sales robot 10. The robot ID specifies the mobile sales robot 10 and is an example of mobile sales device specifying information.

The position information may be indicated by coordinate values such as latitude and longitude. The position information may be indicated by a block number or the like if the movable range of the mobile sales robot 10 is divided into a plurality of blocks.

Examples of the possible states of the mobile sales robot 10 include a state of “moving” in which the mobile sales robot 10 moves to a call position designated by the user, a state of “standby for a transaction” in which the mobile sales robot 10 arrives at the call position and waits for a transaction start operation, and a state of “in transaction” in which a transaction has been started by user operation. Other examples of the possible state of the mobile sales robot 10 include a state of “standby for a call” in which the mobile sales robot 10 is capable of responding to a call from a user while on patrol and a state of “sales unavailable” in which sales by the mobile sales robot 10 cannot be performed because of a commodity out of supply state or the like.

The information stored in the robot management table 3163 is updated by control of an information managing unit 3142 according to the movement of the mobile sales robot 10 and the state of the mobile sales robot 10.

The commodity management table 3164 is a data table for managing commodities sold by each of the mobile sales robots 10. FIG. 11 is a diagram illustrating an example of a data configuration of the commodity management table 3164. As illustrated in FIG. 11, the commodity management table 3164 stores, in correlation with a robot ID, a commodity code of a commodity sold by the mobile sales robot 10 having the robot ID and the number of stocks of the commodity.

The information stored in the commodity management table 3164 is updated by the control of the information managing unit 3142 according to the number of stocks of the commodity stored by the mobile sales robot 10.

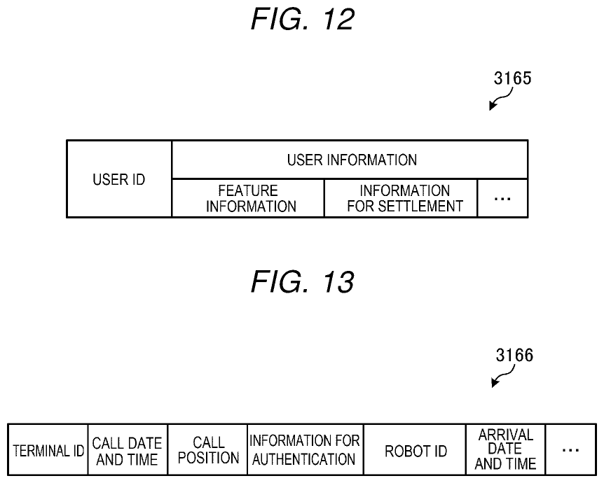

The user management table 3165 is a data table for managing a user using the mobile sales system 1. FIG. 12 is a diagram illustrating an example of a data configuration of the user management table 3165. As illustrated in FIG. 12, the user management table 3165 stores, in correlation with user IDs capable of identifying users, user information concerning the users having the user IDs.

The user information includes feature information indicating features of the faces of the users and information for settlement used for electronic settlement. The feature information is, for example, face images obtained by imaging the faces of the users and feature values indicating the features of the faces and is used as data for collation in face authentication processing. The information for settlement is information such as accounts for using an electronic settlement service contracted by the users in advance. The electronic settlement service includes code settlement, electronic money settlement, credit settlement, and the like. If the electronic settlement service is the credit settlement, the information for settlement may be numbers of credit cards owned by the users.

The user information is acquired from the users by a method such as a standard member registration and registered in the user management table 3165. The user IDs may be automatically allocated or unique information input by the users may be used as the user IDs. The user information is not limited and may include other information. For example, the user information may include personal information such as names, ages, addresses of the users. The user information may include terminal IDs and communication addresses of terminals (the user terminals 20) used by the users, and the like.

The call management table 3166 is a data table for managing a call for the mobile sales robot 10 by the user terminal 20. FIG. 13 is a diagram illustrating an example of a data configuration of the call management table 3166. As illustrated in FIG. 13, the call management table 3166 stores, in correlation with one another, a terminal ID of the user terminal 20 that performs a call, a date and time when the call is received (a call date and time), position information indicating a call position (also referred to as “call position”), information for authentication used for authentication of a calling user, a robot ID of the mobile sales robot 10 that responds to the call, a date and time when the mobile sales robot 10 arrives at the call position (an arrival date and time), and the like.

As the information for authentication, a PIN code having a predetermined number of digits and/or a face image and a user ID of the user can be used. In the former case, the PIN code may be issued by the control unit 314 or may be designated by the user. In the latter case, a face image and a user ID transmitted from the user terminal 20 of the calling user, a user ID specified from the user management table 3165 by the control unit 314 based on the transmitted face image, or the like can be used. In this embodiment, a form in which the control unit 314 issues the PIN code at a call reception time is explained.

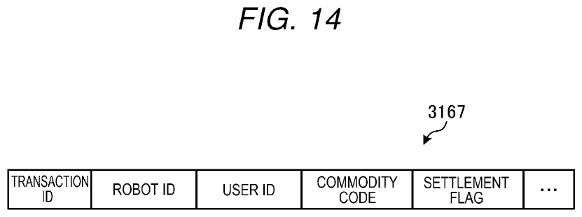

The transaction management table 3167 is a data table for managing a transaction performed via the mobile sales robot 10. FIG. 14 is a diagram illustrating an example of a data configuration of the transaction management table 3167. As illustrated in FIG. 14, the transaction management table 3167 stores, in correlation with a transaction ID for identifying a transaction, a robot ID of the mobile sales robot 10 in which the transaction is performed, a user ID of a user who performs the transaction, a commodity code of a commodity purchased by the user, a settlement flag for discriminating whether settlement is finished, and the like.

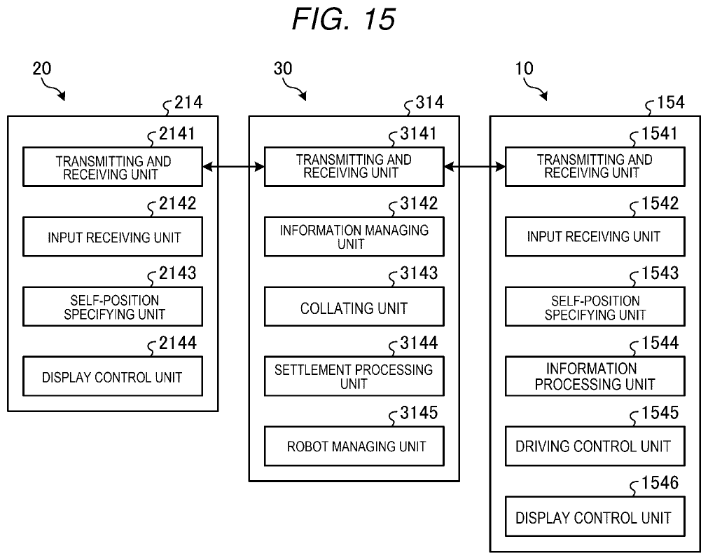

Functional aspects of the devices of the mobile sales system 1 are explained. FIG. 15 is a block diagram illustrating functional aspects of the devices configuring the mobile sales system 1. First, the user terminal 20 is explained.

The CPU 211 operates according to a control program stored in the ROM 212 or the storage unit 220, whereby the control unit 214 of the user terminal 20 functions as a transmitting and receiving unit 2141, an input receiving unit 2142, a self-position specifying unit 2143, and a display control unit 2144. These functions may be implemented by hardware such as a dedicated circuit.

The transmitting and receiving unit 2141 transmits and receives various kinds of information to and from an external device such as the server device 30 via the communication unit 219. A function and an operation of the transmitting and receiving unit 2141 for “receiving” information from the server device 30 and the like can be reworded as “acquisition” of information.

For example, the transmitting and receiving unit 2141 receives information concerning a robot ID, a present position, and a state of the mobile sales robot 10 from the server device 30. The transmitting and receiving unit 2141 transmits a commodity information request and a call request to the server device 30. The commodity information request is a request for designating the mobile sales robot 10 and requesting information concerning commodities stored by the mobile sales robot 10, that is, commodities sold by the mobile sales robot 10. The commodity information request includes information such as a terminal ID of the user terminal 20 and a robot ID of the designated mobile sales robot 10.

The call request is a request for designating the mobile sales robot 10 and requesting a call for the mobile sales robot 10. The call request includes information such as a terminal ID of the user terminal 20, a robot ID of the designated mobile sales robot 10, and a call position. If the user designates information for authentication, the call request further includes the designated information for authentication. In this embodiment, the call position is a position where the user terminal 20 is present, that is, a position positioned by the positioning unit 218. However, a call position desired by the user may be able to be designated by the user terminal 20.

The transmitting and receiving unit 2141 receives commodity information transmitted by the server device 30 in response to the commodity information request. Further, the transmitting and receiving unit 2141 receives a PIN code issued in association with the call request by the server device 30. The PIN code is for authenticating that the user who called the mobile sales robot 10 is the same person as the user who is about to purchase a commodity at the mobile sales robot 10.

Further, the transmitting and receiving unit 2141 receives an arrival notification and a settlement completion notification from the server device 30. The arrival notification indicates that the mobile sales robot 10 arrives at the call position designated by the call request. The settlement completion notification indicates that settlement relating to purchase of a commodity stored in the mobile sales robot 10 is completed.

The input receiving unit 2142 receives input information based on operation of the operation unit 216. For example, the input receiving unit 2142 receives a commodity information request and a call request from the operation unit 216.

The self-position specifying unit 2143 specifies, based on an output of the positioning unit 218, a position of the user terminal 20 in an area represented by the map information 2201.

The display control unit 2144 causes the display unit 215 to display various kinds of information. Specifically, the display control unit 2144 causes the display unit 215 to display various screens (GUIs: Graphical User Interfaces) for supporting purchase of a commodity sold by the mobile sales robot 10. For example, the display control unit 2144 causes the display unit 215 to display a display screen for supporting a call for the mobile sales robot 10.

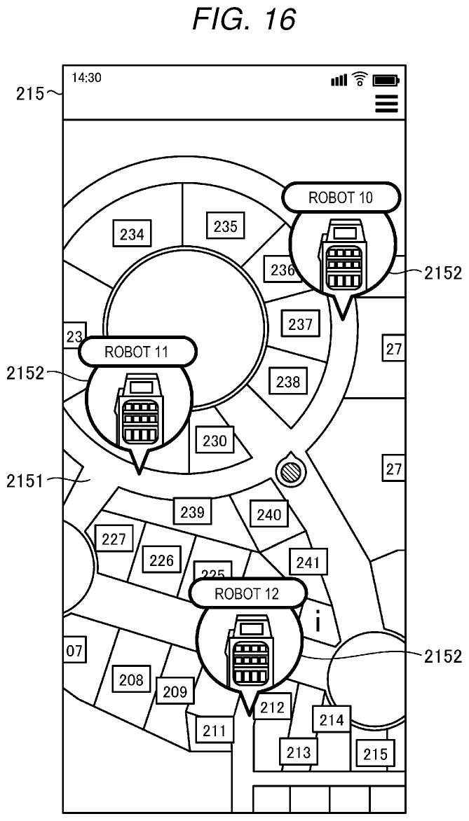

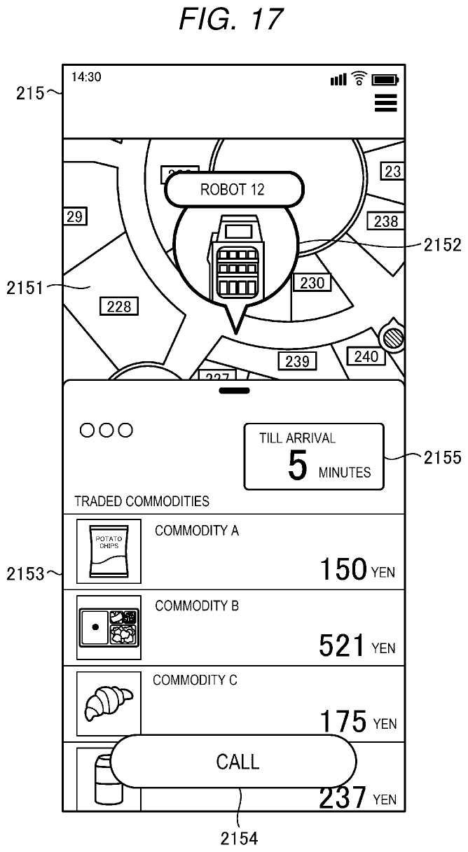

An example of a display screen displayed by the display control unit 2144 is explained with reference to FIGS. 16 and 17. FIG. 16 is a diagram illustrating an example of a first display screen displayed on the display unit 215 of the user terminal 20. FIG. 17 is a diagram illustrating an example of a second display screen displayed on the display unit 215 of the user terminal 20.

The display control unit 2144 causes the display unit 215 to display the mobile sales robots 10 to be selectable on a map to correspond to positions where the mobile sales robots 10 are present and subsequently causes the display unit 215 to display, together with a call button, commodity information of commodities loaded on a selected mobile sales robot 10. Specifically, if a commodity information request menu is selected from a menu selection screen or the like, the display control unit 2144 causes the display unit 215 to display the first display screen illustrated in FIG. 16.

The first display screen includes a map display region 2151. The display control unit 2144 causes, based on the map information 2201, the display unit 215 to display, in the map display region 2151, a map of a range in which the mobile sales robots 10 are movable. The display control unit 2144 may cause, based on position information specified by the self-position specifying unit 2143, the display unit 215 to display a map around a position where the user terminal 20 including the display control unit 2144 is present or may cause, based on position information of the mobile sales robot 10 provided from the server device 30, the display unit 215 to display a map around a position where the mobile sales robot 10 is present. The display control unit 2144 changes, according to operation (for example, scroll operation or enlargement or reduction operation) on the map, the range of the map displayed in the map display region 2151.

The display control unit 2144 causes the display unit 215 to display robot marks 2152 representing the mobile sales robots 10 to be superimposed on the map in the map display region 2151. Specifically, the display control unit 2144 causes the display unit 215 to display the robot marks 2152 in positions where the mobile sales robots 10 are present on the map. Robot identification information such as robot numbers are displayed together with the robot marks 2152.

The user can select, by touching any one of the robot marks 2152 displayed on the first display screen, the mobile sales robot 10 corresponding to the robot mark 2152. If the input receiving unit 2142 receives designation of the mobile sales robot 10, the transmitting and receiving unit 2141 transmits a commodity information request including a terminal ID of the user terminal 20 including the transmitting and receiving unit 2141 and a robot ID of the designated mobile sales robot 10 to the server device 30. The server device 30, which receives the commodity information request, reads out commodity information of a commodity sold by the designated mobile sales robot 10 from the commodity management table 3164 and the commodity master 3162 and transmits the commodity information to the user terminal 20.

If the transmitting and receiving unit 2141 receives the commodity information, as shown on the second display screen illustrated in FIG. 17, the display control unit 2144 causes the display unit 215 to display the commodity information in correlation with the robot mark 2152 of the selected mobile sales robot 10. That is, the second display screen is a screen displayed if any one of the robot marks 2152 displayed on the first display screen is touched.

As illustrated in FIG. 17, the second display screen includes a map display region 2151 and a commodity information display region 2153. Like the map display region 2151 of the first display screen, the map display region 2151 is a region for displaying a map based on the map information 2201. The map display region 2151 is formed smaller than the map display region 2151 of the first display screen. The display control unit 2144 causes the display unit 215 to display, in the map display region 2151, the robot mark 2152 touched on the first display screen and a map round the robot mark 2152.

The commodity information display region 2153 is a region for displaying commodity information of commodities loaded on the selected mobile sales robot 10. The display control unit 2144 causes the display unit 215 to display, in the commodity information display region 2153, commodity information transmitted from the server device 30 according to the selection of the mobile sales robot 10. Specifically, the display control unit 2144 causes the display unit 215 to display the commodity information to be arranged in the up-down direction for each of the commodities. The displayed commodity information is a commodity image, a commodity name, a price, and the like. The commodity information display region 2153 can be scrolled in the up-down direction. The display control unit 2144 updates the displayed commodity information according to scroll operation. Consequently, commodity information of all the commodities loaded on the mobile sales robot 10 can be displayed in the commodity information display region 2153.

The second display screen includes a call button 2154 for calling the selected mobile sales robot 10. The user can check, on the second display screen, the commodities loaded on the mobile sales robot 10 selected on the first display screen and, if there is a commodity that the user desires to purchase, touch the call button 2154 and call the mobile sales robot 10. By calling the mobile sales robot 10 using the first display screen and the second display screen, the user can select the call target mobile sales robot 10 while checking the position of the mobile sales robot 10. Therefore, it is possible to efficiently perform the call for the mobile sales robot 10, for example, call the mobile sales robot 10 closest to the position of the user.

Specifically, if the input receiving unit 2142 receives operation of the call button 2154 on the second display screen, the transmitting and receiving unit 2141 transmits, to the server device 30, a call request including the terminal ID of the user terminal 20 including the transmitting and receiving unit 2141, the robot ID of the designated mobile sales robot 10, and the position information (the call position) specified by the self-position specifying unit 2143. The server device 30 causes the mobile sales robot 10 having the designated robot ID to travel to the designated call position. The server device 30 predicts, based on the present position and the call position of the designated robot ID, the number of call requests corresponding to the robot ID registered in the call management table 3166, and the like, a time until the mobile sales robot 10 corresponding to the robot ID arrives at the call position (referred to as arrival time) and transmits the arrival time to the user terminal 20.

The second display screen includes an arrival time display region 2155 for displaying a time until the selected mobile sales robot 10 arrives at the position of the user terminal 20. The display control unit 2144 causes the display unit 215 to display, in the arrival time display region 2155, the arrival time transmitted from the server device 30 according to the selection of the mobile sales robot 10. The display control unit 2144 may cause the display unit 215 to display, in the arrival time display region 2155, a robot number and the like of the mobile sales robot 10 scheduled to arrive.

Timing for displaying the arrival time is not limited to timing after the operation of the call button 2154. For example, the display control unit 2144 may cause the display unit 215 to display the arrival time at timing when the mobile sales robot 10 is selected on the first display screen. In this case, by transmitting the commodity information request including the position information specified by the self-position specifying unit 2143 to the server device 30, the transmitting and receiving unit 2141 may acquire the arrival time from the server device 30 at the timing when the mobile sales robot 10 is selected.

Further, the second display screen identifiably displays the mobile sales robot 10 selected on the first display screen. Specifically, in the map display region 2151, the robot mark 2152 added with display of a robot number, which is information for identifying the mobile sales robot 10 selected on the first display screen, is displayed together with a map around the robot mark 2152. Consequently, the user can check, about the selected mobile sales robot 10, a position, a number (identification information), commodity information of loaded commodities, and the like of the mobile sales robot 10 on one screen. The identification information added to the robot mark 2152 is not limited to the robot number and may be a robot ID, a name of a robot, or the like.

A display method for the identification information of the selected mobile sales robot 10 is not limited to the above. For example, the identification information of the mobile sales robot 10 may be displayed in the arrival time display region 2155 in association with the arrival time. The identification information of the mobile sales robot 10 may be displayed in the commodity information display region 2153.

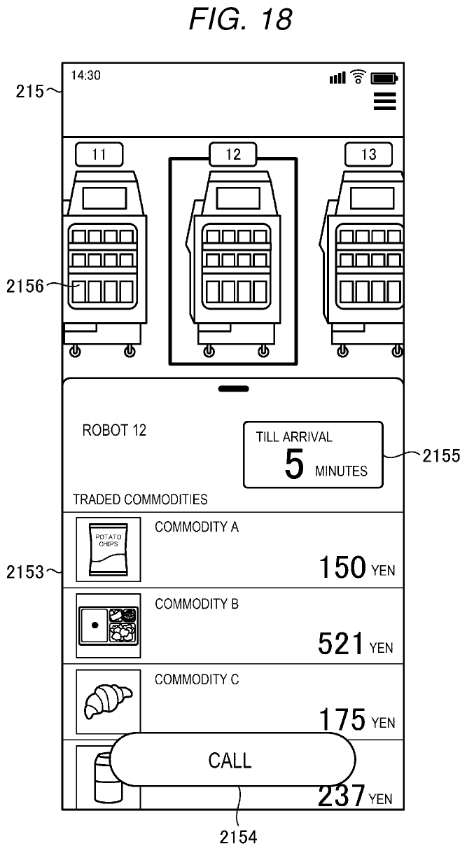

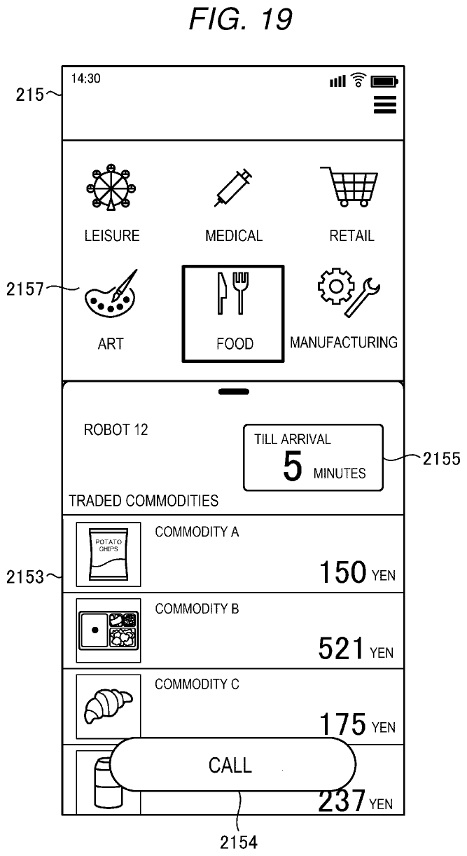

The display screen relating to the call for the mobile sales robot 10 is not limited to the examples illustrated in FIGS. 16 and 17. Other display screens are explained with reference to FIGS. 18 and 19.

FIG. 18 is a diagram illustrating an example of a third display screen displayed on the display unit 215 of the user terminal 20. On the third display screen, the selection of the mobile sales robot 10, the display of the commodity information of the commodity loaded on the mobile sales robot 10, and the call for the mobile sales robot 10 can be performed on the same screen.

Specifically, the third display screen includes a robot selection region 2156, a commodity information display region 2153, a call button 2154, and an arrival time display region 2155.

The robot selection region 2156 is a region for displaying an image (a robot mark) corresponding to each of the mobile sales robots 10 to be selectable. The commodity information display region 2153 is a region for displaying commodity information of commodities sold by the mobile sales robot 10 having the robot mark selected in the robot selection region 2156.

Images of robot marks displayed in the robot selection region 2156 correspond to the mobile sales robots 10 that travel in a predetermined region. The display control unit 2144 causes, based on robot IDs transmitted from the server device 30, position information corresponding to the robot IDs, and the like, the display unit 215 to display a robot mark corresponding to each of the robot IDs in the robot selection region 2156. The robot selection region 2156 can be scrolled in the left-right direction. The display control unit 2144 updates the displayed robot mark according to scroll operation. Consequently, the robot selection region 2156 makes it possible to display all the mobile sales robots 10.

Robot numbers for identifying the mobile sales robots 10 are added to the robot marks. The display control unit 2144 may cause the display unit 215 to display, in correlation with each of the robot marks, a state of the relevant mobile sales robot 10.

The user can select the mobile sales robot 10 by touching any one of the robot marks displayed in the robot selection region 2156. According to the selection of the mobile sales robot 10, the transmitting and receiving unit 2141 transmits, to the server device 30, a commodity information request designating a robot ID of the selected mobile sales robot 10 and acquires commodity information from the server device 30. The display control unit 2144 causes the display unit 215 to display, in the commodity information display region 2153, commodity information of commodities sold by the mobile sales robot 10 selected in the robot selection region 2156.

Consequently, the user can browse, with the commodity information display region 2153, commodity information of commodities stored in the selected mobile sales robot 10. The user can check, in the commodity information display region 2153, the commodities loaded on the mobile sales robot 10 selected in the robot selection region 2156 and, if there is a commodity that the user desires to purchase, touch the call button 2154 and call the mobile sales robot 10. Therefore, the user can perform, without switching a screen, the selection of the mobile sales robot 10, the browsing of the commodity information of the commodities loaded on the selected mobile sales robot 10, and the call for the mobile sales robot 10.

In the arrival time display region 2155, as in the second display screen, an arrival time of the mobile sales robot 10 set as a target of the call (or the selection) is displayed. In the arrival time display region 2155, a robot number of the mobile sales robot 10 set as the target of the call (or the selection) is also displayed.

FIG. 19 is a diagram illustrating an example of a fourth display screen displayed on the display unit 215 of the user terminal 20. On the fourth display screen, the mobile sales robot 10 is not explicitly selected but a commodity or a commodity genre (a type) of the commodity is selected. Therefore, it is possible to select the mobile sales robot 10 loaded with the selected commodity or the commodity in the selected commodity genre. In this embodiment, it is possible to select a commodity genre.

Specifically, the fourth display screen includes a commodity genre selection region 2157, the commodity information display region 2153, the call button 2154, and the arrival time display region 2155.

The commodity genre selection region 2157 is a region for displaying icons indicating commodity genres of commodities loaded on the mobile sales robot 10. The display control unit 2144 causes the display unit 215 to display, in the commodity genre selection region 2157, an icon indicating a commodity genre of a commodity loaded on the mobile sales robot 10 to be selectable. The commodity genres displayed as the icons may be determined in advance. Commodity information of commodities sold in each of the mobile sales robots 10 may be acquired from the server device 30 prior to the display of the fourth display screen. The commodity genres displayed as the icons may be determined based on commodity genres (types) included in the commodity information.

If the user touches any one of the icons displayed in the commodity genre selection region 2157, the transmitting and receiving unit 2141 transmits, for example, identification information for identifying a commodity genre corresponding to the icon to the server device 30. The server device 30 refers to the commodity management table 3164 and extracts the mobile sales robots 10 loaded with commodities of the commodity genre of the received identification information. In this example, it is assumed that the server device 30 includes a management table that associates commodity genres and commodities. The mobile sales robot 10 selected by the server device 30 includes the mobile sales robot 10 loaded with only the commodities of the commodity genre of the received identification information or the mobile sales robot 10 further loaded with commodities of other commodity genres different from the commodity genre.

The server device 30 selects any one of the extracted mobile sales robot 10, for example, the mobile sales robot 10 present in a position closest to the position of the user (the position of the user terminal 20) received together with the identification information of the commodity genre. The server device 30 transmits commodity information of commodities loaded on the selected mobile sales robot 10.

Consequently, the user can select, by touching any one of the icons displayed in the commodity genre selection region 2157, the mobile sales robot 10 loaded with commodities of a commodity genre indicated by the icon. The user can browse, with the commodity information display region 2153, commodity information of commodities stored in the selected mobile sales robot 10. The commodity information display region 2153 and the arrival time display region 2155 are the same as those in the third display screen illustrated in FIG. 18. Therefore, redundant explanation thereof is omitted.

Any one of the methods of calling the mobile sales robot 10 based on the first display screen and the second display screen, the method of calling the mobile sales robot 10 based on the third display screen, and the method of calling the mobile sales robot 10 based on the fourth display screen may be used. The calling method may be able to be switched according to operation of, for example, a switching button.

The display screens illustrated in FIGS. 16 to 19 may be used in combination. For example, the display control unit 2144 causes the display unit 215 to display the fourth display screen first and, if a commodity genre is selected on the fourth display screen, causes the display unit 215 to display the first display screen on which the mobile sales robot 10 loaded with commodities of the selected commodity genre are selectable. The display control unit 2144 may cause the display unit 215 to display the second display screen based on the mobile sales robot 10 selected on the first display screen. In this case, the fourth display screen displayed first may include only the commodity genre selection region 2157.

As explained above, the user terminal 20 performs, according to the user operation, the transmission of the commodity information request, the reception and the display of the commodity information, and the transmission of the call request. In this example, the call position for the mobile sales robot 10 is the position of the user. Before the call request is transmitted to the server device 30, the display control unit 2144 may cause the display unit 215 to display a call position designation screen on which the call position for the mobile sales robot 10 can be designated.

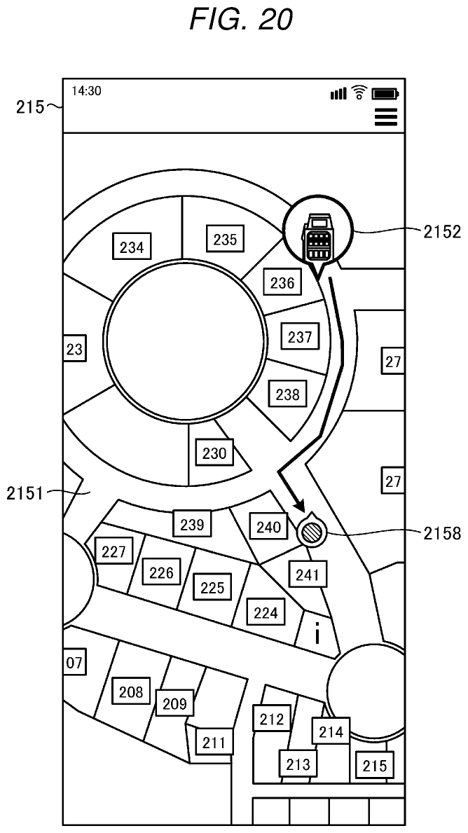

FIG. 20 is a diagram illustrating an example of the call position designation screen displayed on the display unit 215 of the user terminal 20. The call position designation screen includes, for example, the same map display region 2151 as the map display region 2151 of the first display screen. The display control unit 2144 causes the display unit 215 to display, on the map of the map display region 2151, the robot mark 2152 of the selected mobile sales robot 10. On the call position designation screen, the user is capable of designating any position on the map as the call position for the mobile sales robot 10.

The display control unit 2144 causes the display unit 215 to display a designated position mark 2158 in the call position on the map designated by the user. As the designated position mark 2158, a present position of the user, that is, a present position of the user terminal 20 is set as default. The user can move the designated position mark 2158 to a desired position by, for example, performing drag-and-drop operation. Thereafter, the user preforms predetermined operation, whereby the transmitting and receiving unit 2141 transmits a call request including the designated call position to the server device 30. For example, the user touches a call decision button or the like displayed on the map display region 2151, whereby the user terminal 20 may transmit the call request to the server device 30.

After the transmitting and receiving unit 2141 transmits the call request, the display control unit 2144 causes, based on, for example, position information of a call target mobile sales robot 10 provided from the server device 30, the display unit 215 to display a present position of the mobile sales robot 10 on the map of the map display region 2151 using the robot mark 2152 or the like.

By viewing the map of the map display region 2151, the user can easily check the present position of the mobile sales robot 10 selected as the call target.

When the call target mobile sales robot 10 moves to the call position, the display control unit 2144 causes the display unit 215 to display a display screen for informing that the mobile sales robot 10 has arrived at the call position.

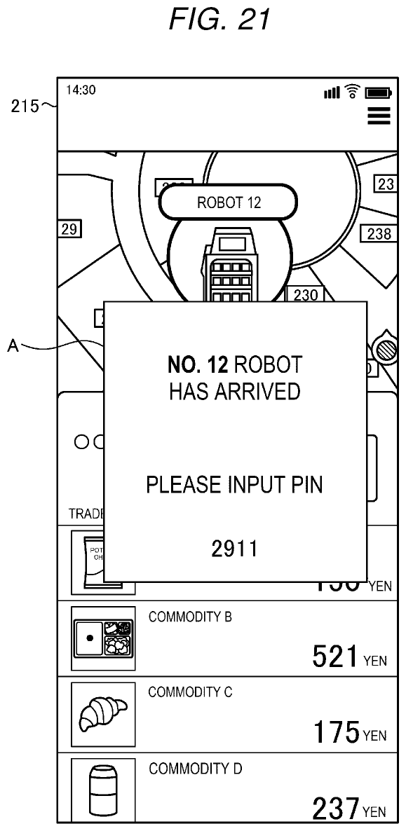

A display screen that the display control unit 2144 causes the display unit 215 to display after the mobile sales robot 10 arrives at the call position is explained with reference to FIG. 21.

FIG. 21 is a diagram illustrating an example of a display screen displayed by the display unit 215 when the mobile sales robot 10 arrives at the call position. If the mobile sales robot 10 arrives at the call position, a push notification is performed from the server device 30 to the user terminal 20. The display control unit 2144 causes, according to the notification from the server device 30, the display unit 215 to popup-display a message A for informing that the mobile sales robot 10 arrives. In FIG. 21, an example is illustrated in which the message A is popup-displayed on the second display screen.

The displayed message A includes a robot number of the arrived mobile sales robot 10 and a message indicating that the mobile sales robot 10 arrives. The message A includes a PIN code received from the server device 30 and a message for urging an input of the PIN code. Consequently, the user can more easily recognize the mobile sales robot 10 that the user calls. Further, the user can also recognize whether it is necessary to input a PIN code to the mobile sales robot 10 and can smoothly start shopping.

In this way, the display control unit 2144 informs using the display screen if the mobile sales robot 10 arrives at the call position. Consequently, by viewing the display screen (the message A), the user can easily recognize that the mobile sales robot 10 arrives at the call position. A method of informing the arrival is not limited to the method using the display screen. For example, the display control unit 2144 may cooperate with an informing unit such as a speaker or a vibrator included in the user terminal 20 to inform, with sound or vibration, that the mobile sales robot 10 arrives at the call position. In this case, the PIN code and the message for urging the input of the PIN code may be displayed on the display unit 215 or may be notified by voice or the like.

In this embodiment, the arrival at the call position is informed according to the notification from the server device 30. However, not only this, but, by the user terminal 20 determining whether the mobile sales robot 10 arrives, the user terminal 20 may uniquely inform the arrival. In this case, for example, the control unit 214 of the user terminal 20 determines whether the position information of the call target mobile sales robot 10 provided from the server device 30 is within a predetermined range starting from the position information of the designated position mark 2158 (the call position). If the mobile sales robot 10 enters the predetermined range, the control unit 214 determines that the mobile sales robot 10 arrives at the call position. In this case, the display control unit 2144 causes, according to the determination of the control unit 214, the display unit 215 to display a display screen for informing that the mobile sales robot 10 arrives at the call position.

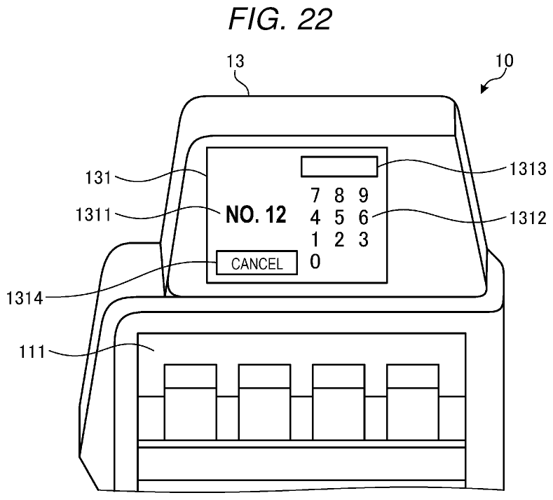

FIG. 22 is a diagram illustrating an example of a PIN code input screen displayed on the display unit 155 (the first display unit 131) of the mobile sales robot 10 if the mobile sales robot 10 arrives at the call position. On the PIN code input screen, a robot number section 1311, an input key section 1312, an input display section 1313, and a cancel button 1314 are formed.

The robot number section 1311 displays a robot number of the mobile sales robot 10. The input key section 1312 displays keys for inputting a PIN code. The input display section 1313 is a section for checking the PIN code input by the input key section 1312 and sequentially displays a number input by the input key section 1312. The cancel button 1314 is a button that the user who called the mobile sales robot 10 presses when the user wishes to cancel shopping without starting the shopping. If the cancel button 1314 is operated, cancel information indicating that the shopping has been cancelled by the user is transmitted to the server device 30. upon receiving the cancel information, the server device 30 transmits a moving instruction including the next moving destination to the mobile sales robot 10.

The user checks the message A displayed on the display unit 215 of the user terminal 20 and inputs a PIN code to the PIN code input screen displayed on the first display unit 131 of the mobile sales robot 10. The mobile sales robot 10 transmits an authentication request including the input PIN code and the robot ID of the mobile sales robot 10 to the server device 30. The server device 30 authenticates, based on the PIN code and the robot ID included in the authentication request, that the user who is about to start shopping is the user who called the mobile sales robot 10.

Once the authentication is performed by the server device 30, the server device 30 transmits an authentication notification to the mobile sales robot 10. The mobile sales robot 10 enables sales processing on condition that the authentication notification is received. The sales processing is a series of processing relating to sales of commodities stored in the storing unit 111 and includes, for example, display processing for causing the display unit 155 to display information relating to the sales of the commodities, commodity registration processing for registering information concerning a commodity taken out from the storing unit 111, and checkout processing relating to checkout of the registered commodity. If not receiving the authentication notification from the server device 30, the mobile sales robot 10 does not execute at least one kind of processing in the series of processing of the sales processing. In other words, if the mobile sales robot 10 does not receive the authentication notification, the user cannot purchase the commodity. Consequently, it is possible to preferentially provide a sales service by the mobile sales robot 10 to the authenticated user, that is, the user who called the mobile sales robot 10.

The display of the PIN code input screen is not limited to be performed by the first display unit 131 and only has to be performed by at least any one of the first display unit 131 to the third display unit 133.

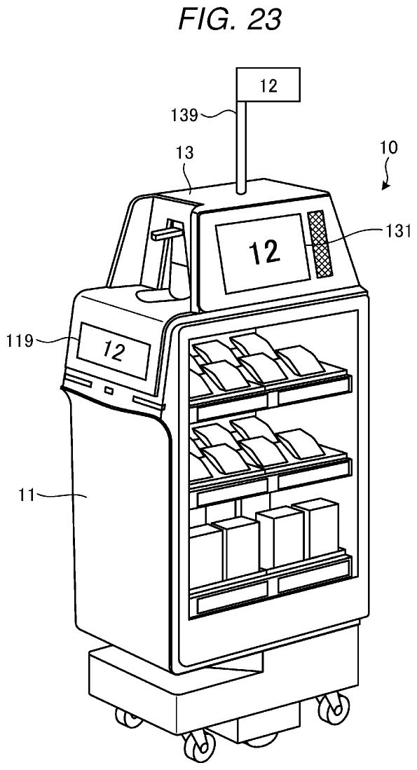

It is desirable to display a robot number on the mobile sales robot 10 such that the user can easily recognize the mobile sales robot 10 designated by the user. FIG. 23 is a perspective view illustrating an example of an exterior configuration of the mobile sales robot 10 in a modification. As illustrated in FIG. 23, the mobile sales robot 10 includes a plate 119 provided on the outer surface of the main body section 11 and a pole 139 provided in the user interface unit 13.

The plate 119 and the pole 139 display the robot number of the mobile sales robot 10. Setting positions of the plate 119 and the pole 139 do not matter. The first display unit 131 displays the robot number of the mobile sales robot 10 during movement of the mobile sales robot 10. The display of the robot number during the movement of the mobile sales robot 10 is not limited to be performed by the first display unit 131 and only has to be performed by at least any one of the first display unit 131 to the third display unit 133. A method of displaying the robot number is optional and may be only any one of the plate 119, the pole 139, and the first display unit 131 (the display unit 155).

In this embodiment, the call request is transmitted from the user terminal 20 carried by the user to the server device 30. However, not only this, but the call request may be transmitted to the server device 30 from a terminal device set in a facility where the mobile sales robot 10 travels. In this case, it is desirable that the terminal device enables the user to set the call position in any place.

Referring back to FIG. 15, functional aspects of the server device 30 are explained. The CPU 311 operates according to a control program stored in the ROM 312 or the storage unit 316, whereby the control unit 314 of the server device 30 functions as a transmitting and receiving unit 3141, the information managing unit 3142, a collating unit 3143, a settlement processing unit 3144, and a robot managing unit 3145. These functions may be implemented by hardware such as a dedicated circuit.

The transmitting and receiving unit 3141 transmits and receives various kinds of information to and from external devices such as the user terminal 20 and the mobile sales robots 10 via the communication unit 315. For example, the transmitting and receiving unit 3141 receives, from each of the mobile sales robots 10, position information indicating a position of the mobile sales robot 10 and state information indicating a state of the mobile sales robot 10. The transmitting and receiving unit 3141 transmits, to the user terminal 20, the position information indicating the position of each of the mobile sales robots 10 and the state information indicating the state of the mobile sales robot 10. Further, the transmitting and receiving unit 3141 receives a commodity information request from the user terminal 20 and transmits commodity information corresponding to the commodity information request to the user terminal 20.

The transmitting and receiving unit 3141 receives a call request from the user terminal 20 and transmits a moving instruction to the mobile sales robot 10 specified by a robot ID included in the call request. The moving instruction is an instruction for instructing the mobile sales robot 10 to move to a call position included in the call request from the user terminal 20. The moving instruction includes information such as a terminal ID of the user terminal 20 that transmits the call request and the call position.

The transmitting and receiving unit 3141 receives an arrival notification from the mobile sales robot 10 and transmits an arrival notification to the user terminal 20 sending the call request for the mobile sales robot 10. The arrival notification is a notification indicating that the mobile sales robot 10 has arrived at the designated call position. The arrival notification includes information such as the robot ID of the mobile sales robot 10 that arrives at the call position.

The transmitting and receiving unit 3141 transmits a PIN code (information for authentication) to the user terminal 20 in response to the call request and receives, from the mobile sales robot 10, a PIN code input to the mobile sales robot 10 by the user. If the PIN code transmitted to the user terminal 20 and the PIN code input to the mobile sales robot 10 are determined to match by the collating unit 3143, the transmitting and receiving unit 3141 transmits an authentication notification to the mobile sales robot 10. The authentication notification indicates that the user who called the mobile sales robot 10 and the user who is now about to start shopping in the mobile sales robot 10 coincide.

Further, the transmitting and receiving unit 3141 receives a settlement request from the mobile sales robot 10 and settlement processing is performed in response to the settlement request, whereby the transmitting and receiving unit 3141 transmits a settlement completion notification to the mobile sales robot 10 and the user terminal 20. The settlement request is a request for requesting settlement processing for a price of commodities purchased by the user in the mobile sales robot 10. The settlement request includes information necessary for the settlement processing executed by the server device 30. The information necessary for the settlement processing is face image data of the user in this embodiment. A user ID or the like may be used instead of the face image data. The settlement completion notification indicates that the settlement is completed in response to the settlement request. The settlement completion notification includes information such as a transaction ID for specifying a settled transaction.

Based on the information received by the transmitting and receiving unit 3141, the information managing unit 3142 stores information in the storage unit 316 and updates various kinds of information stored in the storage unit 316. The information managing unit 3142 reads out, from the storage unit 316, as appropriate, various kinds of information to be transmitted by the transmitting and receiving unit 3141.

For example, the information managing unit 3142 updates the robot management table 3163 based on the position information and the state information received from the mobile sales robot 10 by the transmitting and receiving unit 3141. If the transmitting and receiving unit 3141 receives a commodity information request, the information managing unit 3142 reads out, from the commodity management table 3164, a commodity code corresponding to a robot ID included in the commodity information request. The information managing unit 3142 reads out commodity information corresponding to the commodity code referring to the commodity master 3162.

If the transmitting and receiving unit 3141 receives a call request and an arrival notification, the information managing unit 3142 stores information in the call management table 3166 as appropriate. If the transmitting and receiving unit 3141 receives a settlement request, the information managing unit 3142 stores various kinds of information in the transaction management table 3167 and reads out information for settlement from the user management table 3165. Specifically, the information managing unit 3142 reads out the information for settlement from the user management table 3165 based on face image data included in the settlement request. Further, if the settlement is completed by the settlement processing unit 3144, the information managing unit 3142 updates a settlement flag of the transaction management table 3167.

The information managing unit 3142 manages movement order of the mobile sales robot 10 to a call position. Specifically, about call requests in which arrival date and times are not registered in the call management table 3166, the information managing unit 3142 moves, in order from a call request having the earliest call date and time, the mobile sales robot 10 to a call position designated by the call request.

The collating unit 3143 determines whether the user who called the mobile sales robot 10 and the user who is now about to start shopping at the mobile sales robot 10 match. Specifically, if the transmitting and receiving unit 3141 receives a call request from the user terminal 20, the collating unit 3143 issues a PIN code associated with the call request. The collating unit 3143 determines whether the PIN code received from the mobile sales robot 10 and the issued PIN code coincide.

The collating unit 3143 may determine, with face authentication, whether the user who called the mobile sales robot 10 and the user who is about to start shopping in the mobile sales robot 10 match. In this case, the transmitting and receiving unit 3141 receives face image data from the mobile sales robot 10. The collating unit 3143 refers to the user management table 3165 and performs the comparison based on a feature value of the received face image data and a feature value of the face of the user. In this example, it is assumed that a user ID and a terminal ID are correlated.

The settlement processing unit 3144 executes settlement processing relating to a settlement request received from the mobile sales robot 10 by the transmitting and receiving unit 3141. In this embodiment, the settlement processing unit 3144 executes electronic settlement processing by face authentication. Specifically, the settlement processing unit 3144 performs settlement with a settlement company using information for settlement read out by the information managing unit 3142 based on face image data. The settlement processing unit 3144 communicates with a settlement server of the settlement company to thereby execute settlement processing. The settlement processing unit 3144 may perform electronic settlement with credit card settlement or two-dimensional code settlement.

If the collating unit 3143 determines whether the user (“calling user”) who called the mobile sales robot 10 matches the user who is about to start shopping at the mobile sales robot 10, the mobile sales robot 10 may not need to transmit the face image data to the server device 30 at the settlement request time. This is because the information for authentication is associated with the settlement information in the user management table 3165 and can be used for the settlement processing. Similarly, if a user ID is used as the information for authentication, the mobile sales robot 10 may not need to transmit the face image data to the server device 30 at the settlement request time. In this way, if the information associated with the information for settlement is also used as the information for authentication, it is possible to simplify operation of the user at the settlement request time.

In this case, it is desirable to cause the display unit 215 of the user terminal 20 or the display unit 155 of the mobile sales robot 10 to display a shopping end button that the user operates to end shopping. If the shopping end button is operated, the transmitting and receiving unit 3141 of the server device 30 receives a shopping end notification. The settlement processing unit 3144 does not execute settlement processing based on settlement information of the calling user after the transmitting and receiving unit 3141 receives the shopping end notification. Consequently, after the calling user ends shopping, if another user does shopping until the next user authentication is performed, it is possible to prevent settlement relating to the shopping of the other user from being performed based on the settlement information of the calling user. For example, after the calling user ends shopping in the call position, if another user does shopping at the call position or any position during patrol traveling, it is possible to prevent payment from being made by the calling user.

The robot managing unit 3145 sets a transmission destination and transmission content of transmission of information by the transmitting and receiving unit 3141 based on a call request from the user terminal 20, position information and state information from the mobile sales robots 10, and the like. For example, if the transmitting and receiving unit 3141 receives a call request from the user terminal 20, the robot managing unit 3145 sets the mobile sales robot 10 having a robot ID included in the call request as a transmission destination of a moving instruction and sets a call position included in the call request as transmission content. For example, the robot managing unit 3145 checks state information of the mobile sales robots 10 stored in the robot management table 3163 and selects the mobile sales robot 10 corresponding to the call request out of the mobile sales robots 10 that are in a state of “standby for a call”.

At the same time, the robot managing unit 3145 sets the user terminal 20 sending the call request as a transmission destination, calculates an arrival time until the selected mobile sales robot 10 arrives at the call position, and sets the arrival time as transmission content. The arrival time is calculated based on the number of call requests (unanswered call requests in which arrival date and times are not registered) to the relevant mobile sales robot 10 registered in the call management table 3166, a purchase limit time in one transaction set in advance, position information and state information of the mobile sales robot 10 registered in the robot management table 3163, and the like.

The robot managing unit 3145 refers to the commodity management table 3164 and sets, as a transmission destination of a moving instruction, the mobile sales robot 10 having a robot ID, in which the number of stocks of any one or all of loaded commodities is zero, and sets, as a moving destination, a position to which the commodities are supplied.

The mobile sales robot 10 may include a part or all of the functions by the transmitting and receiving unit 3141, the information managing unit 3142, the collating unit 3143, the settlement processing unit 3144, and the robot managing unit 3145. In this case, the user terminal 20 transmits and receives various kinds of information to and from the mobile sales robot 10.

Functional aspects of the mobile sales robot 10 are explained. The CPU 151 operates according to a control program stored in the ROM 152 or the storage unit 162, whereby the control unit 154 of the mobile sales robot 10 functions as a transmitting and receiving unit 1541, an input receiving unit 1542, a self-position specifying unit 1543, an information processing unit 1544, a driving control unit 1545, and a display control unit 1546. These functions may be implemented by hardware such as a dedicated circuit.

The transmitting and receiving unit 1541 transmits and receives various kinds of information to and from an external device such as the server device 30 via the communication unit 161. For example, the transmitting and receiving unit 1541 transmits position information indicating a position of the mobile sales robot 10 and state information indicating the state of the mobile sales robot 10 to the server device 30 at any time.

The transmitting and receiving unit 1541 receives a moving instruction including a call position from the server device 30. The transmitting and receiving unit 1541 functions as a position-information acquiring unit that acquires position information indicating a call position designated by the user.

Further, the transmitting and receiving unit 1541 transmits an authentication request to the server device 30 and receives an authentication notification from the server device 30. The authentication request is a request for requesting authentication of a PIN code input to the input receiving unit 1542 and includes a PIN code and a robot ID received by the input receiving unit 1542. The authentication notification serves as trigger information for permitting processing relating to commodity sales. The transmitting and receiving unit 1541 functions as an authentication-information acquiring unit that acquires authentication information indicating that a user who is about to purchase a commodity is a user who designates a call position. The transmitting and receiving unit 3141 transmits a settlement request to the server device 30 and receives a settlement completion notification from the server device 30.

The input receiving unit 1542 receives input information based on operation of the operation unit 156. For example, the input receiving unit 1542 receives a PIN code and a settlement instruction input by operation of the user.

The self-position specifying unit 1543 specifies, based on an output of the positioning unit 160, a position of the mobile sales robot 10 on the map information 2201.

The information processing unit 1544 executes various kinds of processing based on various kinds of information input to the mobile sales robot 10.

For example, when the transmitting and receiving unit 1541 receives a moving instruction from the server device 30, the information processing unit 1544 determines a moving route to the call position based on the map information 1621.

If the weight detecting unit 159 detects a weight change of the shelf 112, the information processing unit 1544 reads out, from the stored commodity table 1623, a commodity code corresponding to a shelf ID of the shelf 112 where the weight change occurred and identifies the commodity taken out from the shelf 112 or a commodity returned to the shelf 112. The information processing unit 1544 functions as a detecting unit that detects which commodity has been removed from the shelf 112 (storing unit 111).

For example, if the weight change is a decrease in weight, the information processing unit 1544 reads out commodity codes stored in correlation with the shelf ID of the shelf 112 where the weight change occurs. The information processing unit 1544 refers to the commodity master 1622 and identifies a commodity code corresponding to a decreased weight amount among weights correlated with the commodity codes to identify the commodity removed from the shelf 112. In this case, the information processing unit 1544 reads out commodity information corresponding to the identified commodity code from the commodity master 1622 and registers the commodity information in the RAM 153 (referred to as “commodity registration”). That is, the information processing unit 1544 also functions as a registering unit that executes commodity registration. The information processing unit 1544 reduces a quantity of the specified commodity code stored in the stored commodity table 1623 by the number of articles of the commodity taken out from the shelf 112.

If the weight change is an increase in weight, the information processing unit 1544 reads out commodity codes stored in correlation with the shelf ID of the shelf 112 where the weight change occurs. The information processing unit 1544 refers to the commodity master 1622 and identifies a commodity code corresponding to the increased weight amount among weights correlated with the commodity codes to identify the commodity returned to the shelf 112. In this case, the information processing unit 1544 deletes commodity information corresponding to the identified commodity code from the RAM 153. The information processing unit 1544 increases the quantity of the items corresponding to the specified commodity code stored in the stored commodity table 1623 to reflect the number of items returned to the shelf 112.

The registration of the commodity information may be performed by the server device 30. Specifically, the information processing unit 1544 transmits the commodity code for the commodity removed from the shelf 112 to the server device 30. The server device 30 reads out commodity information corresponding to the received commodity code from the commodity master 3162 and registers the commodity information. In this case, the information processing unit 1544 provides a function of causing the server device 30 to register the commodity information and this can also be considered functioning as a registering unit.

When the input receiving unit 1542 receives a settlement instruction, the information processing unit 1544 executes checkout processing. The checkout processing is processing for the user to make a payment of the purchase price of commodities and, in this embodiment, includes calculation of the total purchase price of the registered commodities, acquisition of face image data, and transmission of a settlement request.

In some examples, the mobile sales robot 10 performs settlement processing that might otherwise be executed by the server device 30. In this case, the settlement processing is included in the checkout processing executed by the information processing unit 1544. The mobile sales robot 10 may include an automatic change machine or the like in order to perform cash settlements. In this case, the information processing unit 1544 controls the automatic change machine. In this way, the information processing unit 1544 functions as a checkout processing unit that executes checkout processing for carrying out a part or entire processing relating to payment of a purchase price. The information processing unit 1544 executes processing relating to commodity sales such as the commodity registration and the checkout processing and functions as a sales processing unit.

The information processing unit 1544 performs voice recognition for voice collected by the sound collecting unit 157 and outputs a stop instruction to the driving control unit 1545 according to necessity. For example, if voice command/request for stopping the mobile sales robot 10 is recognized by the voice recognition, the information processing unit 1544 outputs a stop instruction to the driving control unit 1545.

If the transmitting and receiving unit 1541 receives an authentication notification from the server device 30, the information processing unit 1544 permits processing relating to commodity sales. That is, if the user who called the mobile sales robot 10 and the user who is about to start shopping are determined to match with each other by the collating unit 3143 of the server device 30, the information processing unit 1544 permits the processing relating to commodity sales.

For example, the information processing unit 1544 cooperates with the display control unit 1546 and displays an initial screen for starting shopping on the display unit 155 to permit the processing relating to commodity sales. If a lockable door is provided in the storing unit 111, the information processing unit 1544 unlocks the door to permit the processing relating to commodity sales. The information processing unit 1544 functions as a permitting unit that permits the processing relating to commodity sales if the user who called the mobile sales robot 10 and the user who is about to start shopping match.

In this embodiment, trigger information for permitting the processing relating to commodity sales at the call position is the authentication notification from the server device 30. However, the trigger information might not be set during patrol traveling of the mobile sales robot 10. During patrol traveling, the mobile sales robot 10 stops whenever a voice command/request of the user is received. That is, any position may be a sales position and a specific call request and a PIN code corresponding to the call request do not need to be issued in such circumstances. For commodity sales during the patrol traveling of the mobile sales robot 10, trigger information for permitting commodity sales may not be set at all or other information different from an authentication notification may be set as the trigger information.

For example, it may be detected that the user looks at the imaging unit 134, the user performing a predetermined action such as a blink in front of the imaging unit 134, or the user operating the disinfection device 135 may be set as the trigger information. A user who purchases commodities during the patrol traveling time of the mobile sales robot 10 is capable of purchasing commodities with settlement by face authentication if the user registers information for settlement in the user management table 3165 beforehand. If the mobile sales robot 10 includes a settlement device such as a card settlement terminal or a change machine, a user is capable of purchasing commodities irrespective of presence or absence of registration of the information for settlement.

The information processing unit 1544 executes alarm processing for emitting an alarm according to necessity. For example, if it is detected that a commodity is improperly taken out from the shelf 112 during traveling of the mobile sales robot 10 or in another state in which commodity sales are not permitted, the information processing unit 1544 executes the alarm processing. The alarm processing is processing for causing the light emitting unit 114 to emit light, changing a color of the light to a color representing a warning, or causing a speaker to generate alarm sound in order to notify the surroundings of an abnormality.

The information processing unit 1544 may execute the alarm processing if it is detected that a commodity is about to be fraudulently taken out. For example, the information processing unit 1544 may execute the alarm processing if it is detected that a hand is inserted into the storing unit 111 during traveling of the mobile sales robot 10 or in a state in which the processing relating to commodity sales is not permitted. The information processing unit 1544 functions as an alarm unit that emits an alarm if it is detected that a commodity is to be fraudulently taken out, in other words, if a commodity is fraudulently taken out or is about to be fraudulently taken out.

The driving control unit 1545 controls the driving unit 123 to cause the mobile sales robot 10 to travel or stop. The mobile sales robot 10 performs, according to control of the driving control unit 1545, patrol traveling for traveling in a predetermined route and call traveling for traveling to a call position designated by a customer.

The driving control unit 1545 moves the mobile sales robot 10 to, for example, a back office site or maintenance yard if it is detected that any of commodities stored in the storing unit 111 are out of stock. If the mobile sales robot 10 travels in a shopping mall or the like, the driving control unit 1545 may move the mobile sales robot 10 to a store that provides the commodities that are out of stock for restocking.

The display control unit 1546 controls the display unit 155 to display various kinds of information on the display unit 155. The display control unit 1546 causes the first display unit 131, the second display unit 132, and the third display unit 133 to display contents corresponding to setting positions of the display units. For example, the first display unit 131 displays information concerning a commodity taken out from the storing section 111. In this case, the display control unit 1546 displays information relating to commodity sales and functions as a sales processing unit. The second display unit 132 displays information relating to commodity sales promotion such as information for advertising commodities stored in the storing unit 111. The third display unit 133 displays information relating to commodity settlement such as information for informing a commodity settlement method. If the shelf label 113 is an electronic shelf label, the display control unit 1546 controls display of the electronic shelf label as well.

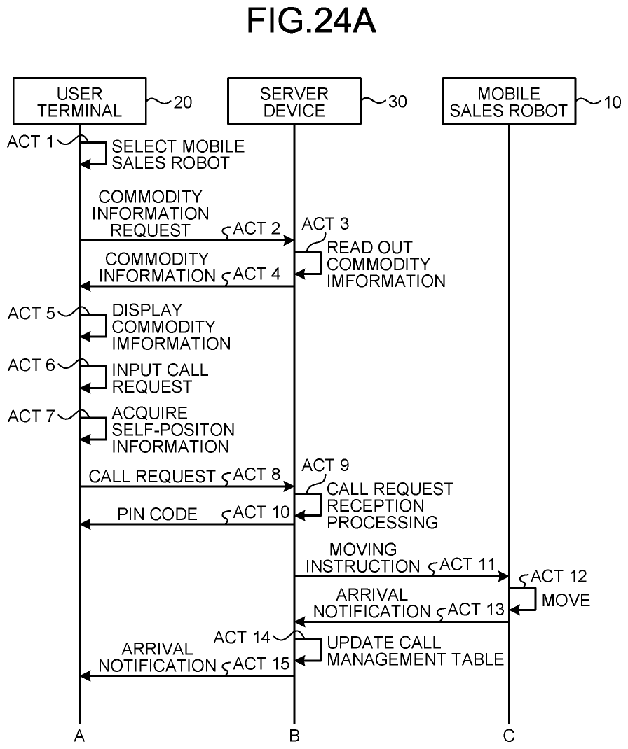

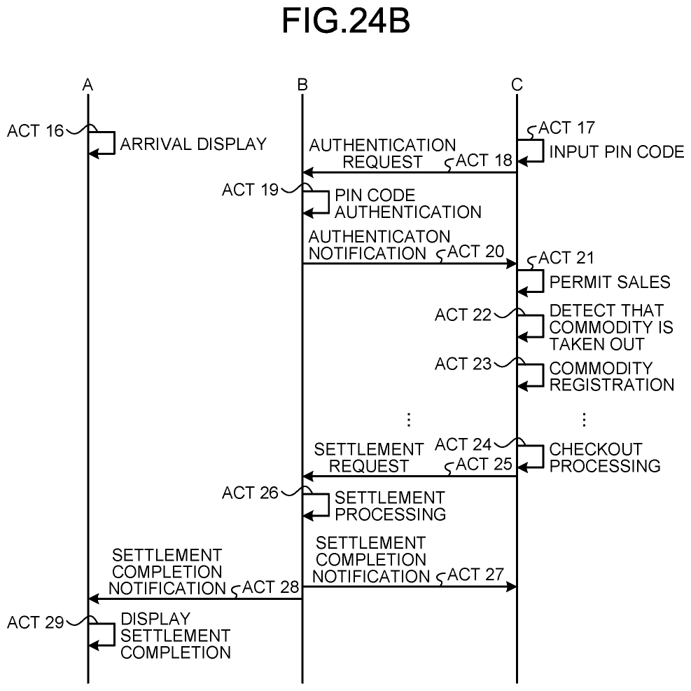

FIGS. 24A and 24B are portions of a sequence chart illustrating an example of the operation of the mobile sales system 1. The sequence chart illustrates a case in which a user checks commodity information of commodities loaded on the mobile sales robot 10, calls the mobile sales robot 10, and purchases the commodities of the mobile sales robot 10.

In calling the mobile sales robot 10, the user starts an application program of the mobile sales system 1 installed in the user terminal 20. If a commodity information request menu is selected, the user terminal 20 displays the first display screen illustrated in FIG. 16 and receives selection of the mobile sales robot 10 (Act 1; see FIG. 24A). The user terminal 20 transmits a commodity information request including a robot ID of the selected mobile sales robot 10 and a terminal ID of the user terminal 20 to the server device 30 (Act 2).

The server device 30 reads out commodity information from the storage unit 316 in response to the received commodity information request (Act 3). Specifically, the server device 30 reads out, from the commodity management table 3164, a commodity code corresponding to the robot ID included in the commodity information request. Subsequently, the server device 30 reads out, from the commodity master 3162, commodity information corresponding to the read-out commodity code. The server device 30 transmits the read-out commodity information to the user terminal 20 (Act 4). A communication address of the user terminal 20 may be registered in the user management table 3165 in advance or may be included in the commodity information request.

The user terminal 20 displays the received commodity information on the display unit 215 (Act 5). If the user checks the displayed commodity information and there is a commodity that the user desires to purchase, the user performs operation for calling the mobile sales robot 10 loaded with the commodity. Consequently, a call request is input to the user terminal 20 (Act 6). The user terminal 20 acquires position information of a place where the user terminal 20 is present (Act 7) and transmits a call request including the acquired position information as a call position to the server device 30 (Act 8).

If receiving the call request, the server device 30 executes call request reception processing (Act 9). The server device 30 manages the received call request with the call request reception processing. The server device 30 transmits a PIN code issued in the call request reception processing to the user terminal 20 (Act 10). The server device 30 transmits a moving instruction including the call position to the mobile sales robot 10 designated by the call request (Act 11).

The mobile sales robot 10 controls the driving unit 123 and moves to the call position designated by the moving instruction (Act 12). When the mobile sales robot 10 arrives at the call position, the mobile sales robot 10 transmits an arrival notification to the server device 30 (Act 13). In some examples, the mobile sales robot 10 may transmit only position information indicating a present position of the mobile sales robot 10 to the server device 30. The server device 30 may then determine the arrival of the mobile sales robot 10 at the call position based on the received position information.

The server device 30 updates the call management table 3166 based on the received arrival notification (Act 14). Specifically, the server device 30 registers an arrival date and time of the relevant call request in the call management table 3166. Subsequently, the server device 30 transmits an arrival notification to the user terminal 20 which sent the call request (Act 15).

Upon receiving the arrival notification, the user terminal 20 displays, on the display unit 215, information indicating that the called mobile sales robot 10 arrives (Act 16; see FIG. 24B). Consequently, the user recognizes the arrival of the mobile sales robot 10 and inputs the PIN code received from the server device 30 to the operation unit 156 of the mobile sales robot 10.

After receiving the input of the PIN code (Act 17), the mobile sales robot 10 transmits an authentication request including the input PIN code and the robot ID to the server device 30 (Act 18).

The server device 30 performs authentication of the PIN code (Act 19). Specifically, the server device 30 authenticates the PIN code if a combination of the PIN code and the robot ID included in the received authentication request is stored in the call management table 3166. The server device 30 authenticates the PIN code and, if it is recognized that the user who performs the call request and the user who is about to start shopping coincide, transmits an authentication notification to the mobile sales robot 10 (Act 20).

Upon receiving the authentication notification, the mobile sales robot 10 permits processing relating to commodity sales (Act 21). Consequently, for example, the mobile sales robot 10 changes display of the display unit 155 from standby to an initial screen for a shopping start. If detecting that a commodity has been taken out from the storing unit 111 (Act 22), the mobile sales robot 10 executes commodity registration for the removed commodity (Act 23). The mobile sales robot 10 executes the commodity registration every time a commodity is removed from any of the shelves 112 and cancels the commodity registration if the commodity is returned to the shelves 112. When a checkout instruction is input, the mobile sales robot 10 executes checkout processing (Act 24). The checkout processing is processing including display of commodity information of commodities to be purchased by the user and acquisition and transmission of information necessary for performing settlement processing in the server device 30. The mobile sales robot 10 transmits a settlement request to the server device 30 based on the checkout processing (Act 25).

The server device 30 executes settlement processing based on the received settlement request (Act 26). The settlement processing is processing for making payment of a purchase price of the user. If settlement is normally completed in the settlement processing, the server device 30 transmits a settlement completion notification to the mobile sales robot 10 (Act 27) and, at the same time, transmits the settlement completion notification to the user terminal 20 as well (Act 28). Upon receiving the settlement completion notification, the user terminal 20 displays, on the display unit 215, information indicating that the settlement has been completed (Act 29).

The mobile sales system 1 thus makes it possible to move the mobile sales robot 10 loaded with commodities to a position designated by the user and sell the commodities. The mobile sales system 1 enables the calling user to do shopping after checking the calling user. Consequently, it is possible to preferentially sell the commodities to the calling user.

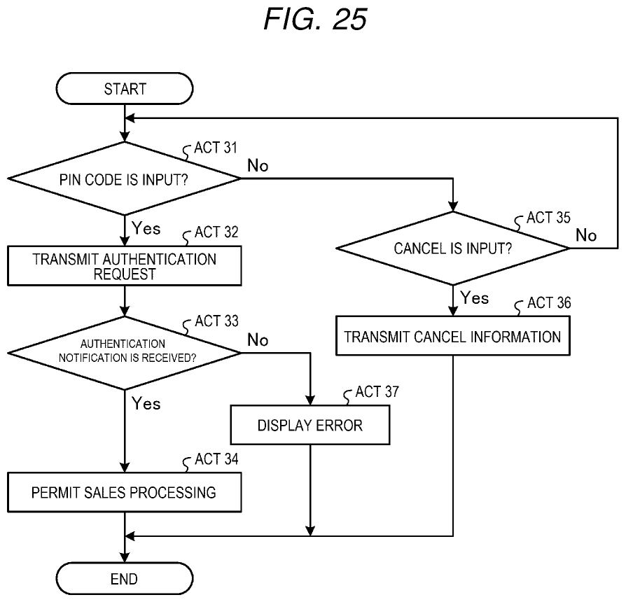

Subsequently, sales permission processing executed by the mobile sales robot 10 is explained. FIG. 25 is a flowchart illustrating an example of a flow of the sales permission processing by the control unit 154 of the mobile sales robot 10.

The control unit 154 determines whether the input receiving unit 1542 receives an input of a PIN code (Act 31). If the input receiving unit 1542 receives the input of a PIN code (Y in Act 31), the transmitting and receiving unit 1541 transmits an authentication request including the received PIN code to the server device 30 (Act 32).

Subsequently, the control unit 154 determines whether the transmitting and receiving unit 1541 receives an authentication notification from the server device 30 (Act 33). If the transmitting and receiving 1541 receives the authentication notification (Y in Act 33), the information processing unit 1544 permits sales processing (Act 34). Specifically, the information processing unit 1544 cooperates with the display control unit 1546, displays an initial screen for starting shopping on the display unit 155, and permits the sales processing. If a lockable door is provided in the storing unit 111, the information processing unit 1544 may unlock the door to permit the sales processing. The control unit 154 ends the sales permission processing.

If the input receiving unit 1542 does not receive the input of a PIN code in the processing in Act 31 (N in Act 31), the control unit 154 next determines whether the input receiving unit 1542 receives a cancel input (Act 35) and, if not (N in Act 35), returns to the processing in Act 31.

If the input receiving unit 1542 receives the cancel input (Y in Act 35), the transmitting and receiving unit 1541 transmits cancel information to the server device 30 (Act 36). The control unit 154 ends the sales permission processing. The server device 30 then determines that the user who called the mobile sales robot 10 will not do shopping. The server device 30 transmits a moving instruction to the mobile sales robot 10.

If the transmitting and receiving unit 1541 does not receive the authentication notification from the server device 30 in the processing of Act 33 (N in Act 33) or if the transmitting and receiving unit 1541 receives a notification to the effect that user authentication has not been performed, the display control unit 1546 displays an error on the display unit 155 (Act 37). The error display is a message or the like indicating that there is an error in the input PIN code.

In this case, the information processing unit 1544 does not permit sales processing. For example, the information processing unit 1544 cooperates with the display control unit 1546, does not display the initial screen for starting shopping on the display unit 155, and performs an error display. If a commodity is taken out from the storing unit 111 in this state, the information processing unit 1544 emits an alarm without executing commodity registration. Further, the information processing unit 1544 prohibits reception of a checkout instruction input. Specifically, the information processing unit 1544 performs the error display on the display unit 155 to prohibit display of a checkout instruction button for performing the checkout instruction input. Then, the control unit 154 ends the sales permission processing.

According to the sales permission processing, the mobile sales robot 10 can preferentially sell commodities to the user who called the mobile sales robot 10. Consequently, it is possible to appropriately attend to a user who desires a mobile sales service.

### Second Embodiment

The second embodiment is different from the first embodiment in that a PIN code is not used for user authentication and the user terminal 20 transmits an authentication request. In the following, components and functions which are substantially the same as those in the first embodiment may be omitted from additional description. This is to avoid redundant explanation and facilitate understanding of those skilled in the art.

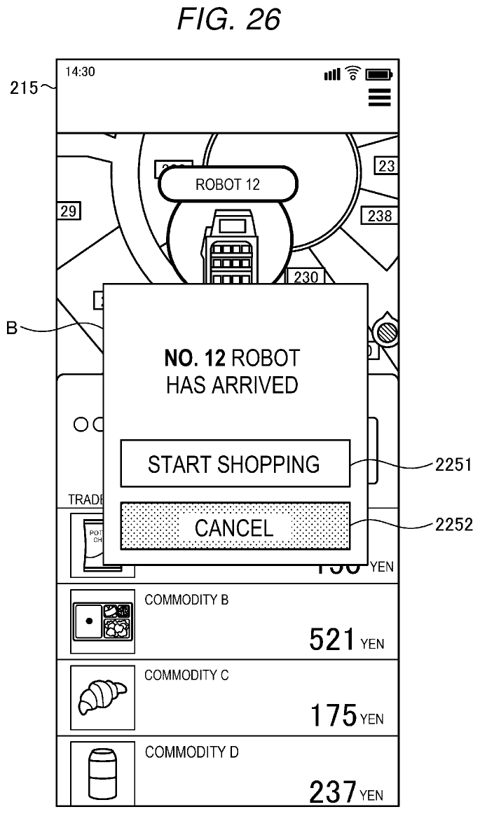

FIG. 26 is a diagram illustrating an example of a display screen displayed by the display unit 215 of the user terminal 20 if the mobile sales robot 10 arrives at a call position in this embodiment. As in the first embodiment, if the mobile sales robot 10 arrives at the call position, a message B for informing that the mobile sales robot 10 arrives is popup-displayed on the display unit 215 of the user terminal 20. The displayed message B includes a robot number of the arrived mobile sales robot 10 and a message indicating that the mobile sales robot 10 arrives. The message B includes a shopping start button 2251 and a cancel button 2252.

The shopping start button 2251 is a button that a user, who confirms the arrival of the called mobile sales robot 10, operates in starting shopping. If the shopping start button 2251 is operated, the user terminal 20 transmits an authentication request including a robot ID of the arrived mobile sales robot 10 and a terminal ID to the server device 30. The robot ID is included in an arrival notification received from the server device 30 by the user terminal 20. If a combination of the robot ID and the terminal ID included in the authentication request is present in the call management table 3166, the server device 30 determines that a user of the user terminal 20 at an authentication request source and a user who called the mobile sales robot 10 match.

The cancel button 2252 has the same function as the cancel button 1314 displayed on the mobile sales robot 10 in the first embodiment and is a button operated when a user cancels shopping without starting. If the cancel button 2252 is operated, the user terminal 20 transmits cancel information including the robot ID and the terminal ID to the server device 30. The server device 30 updates the call management table 3166 and outputs a moving instruction to the mobile sales robot 10.

Upon recognizing the arrival of the mobile sales robot 10 with the message B, the user visually checks whether a robot number displayed on the arrived mobile sales robot 10 and a robot number displayed in the message B coincide. To starting shopping, the user operates the shopping start button 2251. If cancelling the shopping, the user operates the cancel button 2252.

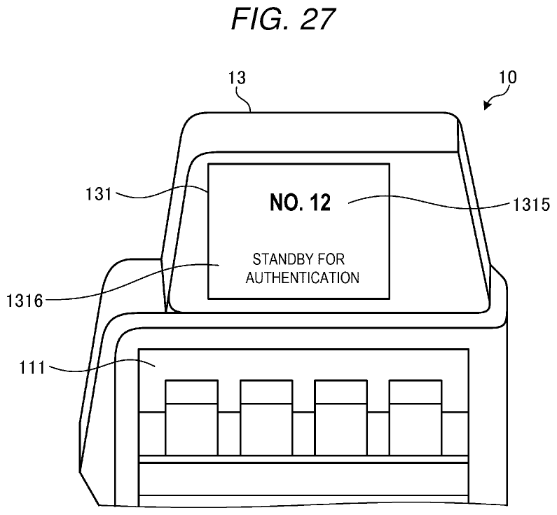

FIG. 27 is a diagram illustrating an example of a display screen displayed on the display unit 155 (the first display unit 131) of the mobile sales robot 10 when the mobile sales robot 10 arrives at a call position. A robot number section 1315 and a standby message section 1316 are formed on the display screen.

The robot number section 1315 displays the robot number of the mobile sales robot 10. The standby message section 1316 displays a message indicating that the mobile sales robot 10 is in a standby state in which user authentication is not performed. If receiving an authentication notification from the server device 30, the mobile sales robot 10 changes display of the first display unit 131 to an initial screen for a shopping start. The display of the display screen is not limited to be performed by the first display unit 131 and only has to be performed by at least any one of the first display unit 131 to the third display unit 133.

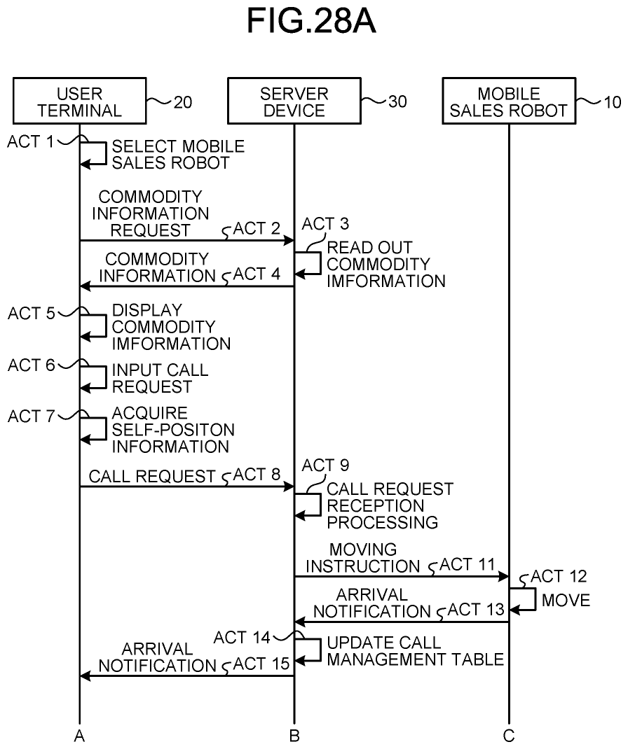

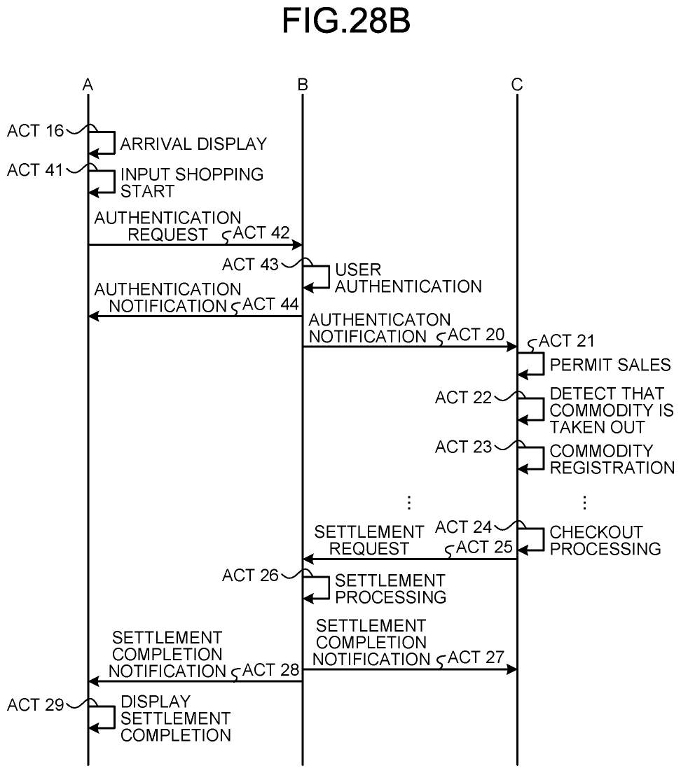

Subsequently, an operation of the mobile sales system 1 in this second embodiment is explained. FIGS. 28A and 28B are portions of a sequence chart illustrating an example of the operation of the mobile sales system 1. The sequence chart illustrates a case in which a user checks commodity information of commodities loaded on the mobile sales robot 10, calls the mobile sales robot 10, and purchases the commodities of the mobile sales robot 10. The same processing as the processing in the first embodiment is denoted by the same reference signs and explanation of the associated processing is omitted.

Processing in Act 1 to Act 16 is the same as the processing in the first embodiment. When arrival display is performed on the user terminal 20 and the user operates the shopping start button 2251, a shopping start is input to the user terminal 20 (Act 41; see FIG. 28B). The user terminal 20 transmits an authentication request to the server device 30 (Act 42).

The server device 30 performs user authentication based on the received authentication request (Act 43). Specifically, the server device 30 performs the user authentication based on the call management table 3166 and a combination of the robot ID and the terminal ID included in the authentication request (Act 43) and transmits an authentication notification to the user terminal 20 (Act 44). The subsequent processing in Act 20 to Act 29 is the same as the processing in the first embodiment.

The user can thus perform the authentication request just by operating the shopping start button 2251 displayed on the user terminal 20 of the user. Therefore, it is possible to further improve operability of the user.

The mobile sales robot 10 in certain embodiments explained above includes the storing unit 111 that stores a commodity to be sold and the driving unit 123 that moves the mobile sales robot 10. The mobile sales robot 10 also includes a position-information acquiring unit (the transmitting and receiving unit 1541) that acquires position information indicating a call position designated by a user, the driving control unit 1545 that controls the driving unit 123 based on the position information acquired by the position-information acquiring unit, a sales processing unit (the information processing unit 1544) that executes sales processing for the items stored in the storing unit 111, an authentication-information acquiring unit (the transmitting and receiving unit 1541) that acquires authentication information indicating that a user who is about to purchase the commodity is the user who designates the call position, and a permitting unit (the information processing unit 1544) that permits completion of the sales processing by the sales processing unit on condition that the authentication-information acquiring unit acquired the authentication information.

Thus, the mobile sales robot 10 can sell an item at the call position designated by the user. The mobile sales robot 10 can preferentially sell to a user who has been confirmed as being the user who called the mobile sales robot 10. Therefore, it is possible to appropriately attend to a user who desires a mobile sales service.

In an embodiment, the control programs executed by the mobile sales robot 10, the user terminal 20, and the server device 30 may be recorded in a computer-readable recording medium such as a CD-ROM and provided. The control programs executed by the devices may be stored on a computer connected to a network such as the Internet and provided by being downloaded through the network and, further, may be accessed through the network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mobile sales device, comprising:
a storage unit configured to hold items to be sold;
a driving unit configured to move the storage unit from location to location;
a communication interface configured to connect to a server device; and
a processor configured to:
acquire position information indicating a call position designated by a call requesting user from the server device;
control the driving unit based on the position information;
acquire authentication information from a user at the call position to determine whether the user at the call position is the call requesting user; and
permit execution of sales processing relating to items in the storage unit only if the acquired authentication information indicates that the user at the call position is the call requesting user.

2. The mobile sales device according to claim 1, wherein
sales processing includes commodity registration for an item removed from the storage unit, and
the item is identified as removed from the storage unit based on a weight change amount detected for a shelf in the storage unit.

3. The mobile sales device according to claim 1, further comprising:
a camera, wherein
the authentication information is a facial image acquired by the camera.

4. The mobile sales device according to claim 1, further comprising:
a user input unit, wherein
the authentication information is a PIN code acquired via the user input unit.

5. The mobile sales device according to claim 1, further comprising:
an alarm unit configured to emit an alarm if it is detected that an item is removed from the storage unit during a period in which sales processing is not being executed.

6. The mobile sales device according to claim 1, further comprising:
a payment processing unit configured to receive payments from the call requesting user.

7. The mobile sales device according to claim 1, wherein the payment processing unit includes a credit card reader.

8. A mobile vending robot, comprising:
a housing;
a storage unit in the housing and configured to hold items to be sold;
a driving unit configured to move the housing from location to location;
a positioning sensor configured to provide present location information; and
a communication interface configured to connect to a server device; and
a processor configured to:
acquire a call position designated by a call requesting user from the server device;
control the driving unit to move to the call position;
upon arrival at the call position, attempt to acquire authentication information from a user at the call position to determine whether the user at the call position is the call requesting user; and
permit execution of sales processing relating to items in the storage unit at the call position only if the acquired authentication information indicates that the user at the call position is the call requesting user.

9. The mobile vending robot according to claim 8, wherein the processor is further configured to:
stop movement of the driving unit at a position other than the call position in response to a signal from a user at the position other than the call position; and
permit execution of sales processing relating to items in the storage unit at the position without attempting to acquire authentication information.

10. The mobile vending robot according to claim 9, wherein the signal is a voice command to stop.

11. The mobile vending robot according to claim 8, wherein
sales processing includes commodity registration for an item removed from the storage unit, and
the item is identified as removed from the storage unit based on a weight change amount detected for a shelf in the storage unit.

12. The mobile vending robot according to claim 8, further comprising:
a camera, wherein
the authentication information is a facial image acquired by the camera.

13. The mobile vending robot according to claim 8, further comprising:
a user input unit, wherein
the authentication information is a PIN code acquired via the user input unit.

14. The mobile vending robot according to claim 8, further comprising:
an alarm unit configured to emit an alarm if it is detected that an item is removed from the storage unit during a period in which sales processing is not being executed.

15. A mobile sales system, comprising:
a server device;
a user terminal device permitting a call requesting user to designate a call position, the user terminal device transmitting the designated call position to the server device; and
a mobile vending robot including:
a storage unit configured to hold items to be sold;
a driving unit configured to move the storage unit from location to location;
a communication interface configured to connect to the server device; and
a processor configured to:
acquire position information indicating the call position from the server device, the call position being designated by a call requesting user via the user terminal device;
control the driving unit based on the position information;
acquire authentication information from a user at the call position to determine whether the user at the call position is the call requesting user; and
permit execution of sales processing relating to items in the storage unit only if the acquired authentication information indicates that the user at the call position is the call requesting user.

16. The mobile sales system according to claim 15, wherein
sales processing includes commodity registration for an item removed from the storage unit, and
the item is identified as removed from the storage unit based on a weight change amount detected for a shelf in the storage unit.

17. The mobile sales system according to claim 15, wherein the mobile vending robot further includes:
a camera, wherein
the authentication information is a facial image acquired by the camera.

18. The mobile sales system according to claim 15, wherein the mobile vending robot further includes:
a user input unit, wherein
the authentication information is a PIN code acquired via the user input unit.

19. The mobile sales system according to claim 15, wherein the mobile vending robot further includes:
an alarm unit configured to emit an alarm if it is detected that an item is removed from the storage unit during a period in which sales processing is not being executed.

20. The mobile sales system according to claim 15, wherein the mobile vending robot further includes:
a payment processing unit configured to receive payments from the call requesting user.
